(19) United States
(12) Patent Application Publication
(10) Pub. No.: US 2010/0200195 A1
(43) Pub. Date: Aug. 12, 2010

(54) HIGH-PERFORMANCE HEAT EXCHANGER FOR AUTOMOTIVE VEHICLES, AND HEATING/AIR-CONDITIONING DEVICE INCLUDING A HIGH-PERFORMANCE HEAT EXCHANGER

(75) Inventor: Johann Himmelsbach, Lindlar (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: AUTOMOTIVETHERMOTECH GMBH, Lindlar (DE)

(21) Appl. No.: 12/595,520

(22) PCT Filed: Apr. 11, 2008
(86) PCT No.: PCT/DE2008/000613

§ 371 Date: Oct. 12, 2009

(30) Foreign Application Priority Data
Apr. 12, 2007 (DE) 10 2007 017 567.6
Jan. 3, 2008 (DE) 10 2008 003 149.6
Jan. 3, 2008 (DE) 10 2008 003 151.8

(51) Int. Cl. B60H 1/00

(52) U.S. Cl. 165/51

(57) ABSTRACT

A heating/air-conditioning device includes a high-performance heat exchanger for providing air-conditioning of the vehicle cab of passenger cars and is designed and optimized for the large-scale production of passenger cars concerning quantity and costs. The construction size of a heat exchanger, which is already designed as a high-performance heat exchanger and has a soldered matrix, is enlarged beyond the previously known size, so that the vehicle delivers the same heating power as the previous basic series including a much more expensive PTC auxiliary heater. In addition to cost savings, fuel is saved in an order of 0.5-1.01/100 km, compared to an operation with a PTC auxiliary heater and at the same heating power. The heat exchanger employed here, which includes coolant-side flat tubes and air-side fins having a plurality of turbulence-producing recesses (louvers) following each other in the air flow direction, preferably has a volume V_matrix of the heat exchanger matrix washed round from the heating air, and a center-to-center spacing of the air-side fins t_fin and a center-to-center spacing of the flat coolant tubes t_tube, such that the specific heat exchanger volume V_spec produced therefrom by using the equation V_spec=V_matrix/(t_tube+(4*t_fin)) exceeds a lower limit of 0.140 m².

### CROSS-REFERENCE TO RELATED APPLICATIONS

This application is a Section 371 of International Application No. PCT/DE2008/000613, filed Apr. 11, 2008, which was published in the German language on Oct. 23, 2008, under International Publication No. WO 2008/125089 A2 and the disclosure of which is incorporated herein by reference.

### BACKGROUND OF THE INVENTION

This invention relates to a high-performance heat exchanger for providing air-conditioning of the vehicle cab of passenger cars produced on a large scale using exhaust heat of liquid-cooled driving components, particularly using the exhaust heat of liquid-cooled combustion engines, said high-performance heat exchanger including a heat transfer matrix. The invention further relates to a heating/air-conditioning device including such a high-performance heat exchanger, and to a vehicle platform comprising vehicles equipped with such a heating/air-conditioning device or such a heat exchanger.

A common feature of modern passenger cars is that the same provide especially for Diesel vehicles an electric PTC (positive temperature coefficient) auxiliary heater for additionally heating cab air that is heated by the heat exchanger. While the basic heating/air-conditioning devices are structurally identical in the Diesel and Otto variants, this technique provides the addition of a PTC auxiliary heater in the Diesel variant, but not in the variant with an Otto engine. To save the costs for the PTC auxiliary heater, which are not negligible, most of the vehicle manufacturers make a difference concerning the standard installation of an auxiliary heater in the Diesel variants or even offer an auxiliary heater only as optional equipment, depending on the vehicle market.

The latest development in the field of heating/air-conditioning devices in large-scale passenger vehicle applications is also characterized by the use of increasingly compact heat exchangers. Particularly, an increasing use of soldered aluminum heat exchangers can be noticed, and the manufacturing costs which are higher compared to heat exchanges that are “plugged together” or otherwise mechanically assembled, i.e. without soldering, are accepted in order to save installation space.

The general view of the technical world that a further increase in efficiency of heat exchangers does not bring important benefits concerning the heating performance, because the heat exchangers have generally arrived at their level of thermal saturation, and also the view that the target values of the heating performance in Diesel engines are achieved in the most cost-efficient way especially by the interaction between the electric PTC auxiliary heating and the conventional heat exchanger, resulted in that many passenger car heating/air-conditioning devices meanwhile have a very similar structure comprising a standard heat exchanger, an air-side downstream PTC auxiliary heater and an air-side heater control. Especially new fabrication techniques and aluminum alloys have been used in this respect during the last years, primarily for still further reducing the installation space for the heat exchanger or the heating/air-conditioning device while maintaining the efficiency level of the heat exchanger.

In the case of soldered all-aluminum heat exchangers for passenger vehicles, the packing density of the coolant-side heat transfer tubes and of the air-side heat transfer fins is in many applications at a level that was hardly imaginable ten years ago. The highest packing density presently known in pure passenger vehicles can be found in the heat exchanger of the current BMW 3 Series, with a center-to-center tube spacing t_tube of approx (3.9+1.3=5.2 mm) and an (average) center-to-center fin spacing t_fin of approx 0.85 mm. For the definition of t_tube and t_fin within the scope of the invention, FIG. 3 shows these two dimensions in a soldered heat exchanger comprising a coolant inlet 1 and outlet 2 as well as coolant-side flat tubes 3 and air-side fins 4 forming the heat exchanger matrix by soldering. In the air flow direction, i.e. perpendicular to the image plane in FIG. 3, it shall apply within the scope of the invention that empty intermediate spaces between individual groups of heat exchanger tubes in the air flow direction belong to the matrix volume, provided that air can flow through these intermediate spaces. The air-side fin recesses (louvers), which are normally indispensible in high-performance passenger car heat exchangers, are not illustrated for the sake of simplification. The volume of the heat exchanger matrix, i.e. the volume of the heat exchanger section through which air flows, here amounts to approx 0.98 l, and the construction depth of the matrix in the air flow direction to approx 27 mm. The water tank increases the construction depth of the heat exchanger of this typical vehicle representing the higher middle class, in which the demands are already higher, to finally 32 mm.

The heat exchangers of other volume manufacturers in the same vehicle class exhibit a slightly larger matrix volume of the heat exchangers at a packing density of the flat tubes and fins which is slightly smaller. But here, too there is an obvious trend toward a higher packing density of the matrix or to a smaller construction volume. While up to ten years ago construction volumes of approx 1.2-1.5 l matrix volume were quite customary in the Golf class and also in the upper middle class, today the corresponding parameter in new vehicle applications normally is around 0.7-1.1 l. Less compact, soldered heat exchangers having a flat tube center-to-center distance of more than 7 mm can be found in completely new vehicle applications only in very exceptional cases.

In this context, the table in FIG. 4, which will be discussed in more detail further down, shows a survey concerning the dimensions of typical passenger vehicle heat exchangers as preferably installed today in mass production. However, the Honda Odyssee, which is additionally shown therein, already belongs to the segment of the large capacity limousines (vans).

All the known heating/air-conditioning devices have in common that the PTC auxiliary heater in connection with soldered and also with “plugged” heat exchangers cause considerable additional costs, namely on the one side for the installation of the PTC auxiliary heating components in vehicles having a Diesel engine, and on the other side also in vehicles having an Otto engine, i.e. those vehicles in which a PTC auxiliary heater is normally not installed. In this latter case additional costs conditional on PTC occur for example through the provision of the installation space and the basic conditions for the electric auxiliary heating for Diesel variants. A further factor is the considerably increased fuel consumption in all operation situations in which the PTC auxiliary heater is in operation. Compared to the PTC auxiliary heater, alternative concepts of auxiliary heating as used today in mass production passenger vehicles are either characterized by a fuel consumption which is even more increased and/or by even higher additional costs.

### BRIEF SUMMARY OF THE INVENTION

In view of the above, the invention is based on the object of providing a high-performance heat exchanger and a heating/air-conditioning device including such a high-performance heat exchanger for mass production passenger cars, wherein the heating/air-conditioning device as an alternative to the today's standard of heat exchangers or heating/air-conditioning devices in Diesel passenger vehicles not only achieves the target values of the heating performance, but also allows a reduction of the total fabrication costs and at the same time a reduced fuel consumption. Further, a corresponding vehicle platform application producible on a large scale shall be provided.

This object is achieved by the high-performance heat exchanger and by the heating/air-conditioning device as well as the vehicle platform application according to embodiments of the present invention.

Together with an appropriate vehicle integration, a high-performance heat exchanger according to embodiments of the invention allows the construction of a highly efficient and low-cost vehicle heating without a PTC auxiliary heater for Diesel engines, based upon the substantial use of fabrication techniques available on the market and of semi-products for high-performance heat exchangers having a soldered heat transfer matrix, i.e. based upon coolant-side flat tubes and air-side fins with a plurality of turbulence-producing recesses (louvers) following one after the other in the air flow direction. The heat exchanger of the invention or the heating/air-conditioning device is thus preferably intended for or installed in a Diesel vehicle that preferably includes no air-side or generally no PTC auxiliary heater or other auxiliary heater related to the heat exchanger. Preferably, the specific heat exchanger volume V_spec exceeds a lower limit value of 1.050 or of 0.160 m², particularly preferably a lower limit value of 0.170 or 0.180 m², or of 0.20 or 0.25 m². Here, V_spec of the heat exchanger according to the invention can be less than or equal 0.60 to 0.70 m², for example less than or equal 0.50 to 0.40 m² or less than 0.25 to 0.30 m², without being limited thereto.

The air-side flow passages are preferably formed by the surfaces of the coolant-side heat exchanger passages facing away from the coolant and by the air-side metal fins fixed to them by soldering and having a plurality of turbulence-producing recesses of the air-side heat transfer fins transversely to the air flow.

Independently of or in combination with a heat exchanger according to embodiments of the invention, the object is achieved by a heating/air-conditioning device according to embodiments of the invention, including front air vents directing air heated by the air-conditioning device to the foot space of the vehicle and including a heat exchanger which is configured in such a way that at an operating point which is particularly relevant for the heating and at which the air inlet temperature (T_{air, heat exchanger,inlet}) is −20° C., the coolant inlet temperature (T_{coolant,heat exchanger,inlet}) is 50° C., a heating air mass flow is 5 kg/min and the coolant flow rate is 5 l/min, the heat exchanger achieves an average air outlet temperature at the front foot vents (T_{air,foot vent,front}) which, with the air mass flow and thus the heating power being focused on the foot vents, is as high that the total heat efficiency Phi, calculated by the equation Phi=100*(T_{air,foot vent,front}−T_{air,heat exchanger,inlet})/(T_{coolant, heat exchanger,inlet}−T_{air, heat exchanger,inlet}), exceeds a value of 85%, 90% or 95%, without an air-side auxiliary heater. This can be achieved by suitably selecting the specific heat exchanger volume V_spec and by sufficiently sealing the temperature regulation flaps to avoid leak points and losses on part of the heating device. The heat exchanger of the air-conditioning device preferably includes a soldered heat transfer matrix. Heating air can flow around the heat transfer matrix that comprises or consists of coolant-side flat tubes and air-side fins with a plurality of turbulence-producing recesses following one after the other in the air flow direction. The heat transfer matrix can be constructed in such a manner that the specific heat exchange volume V_spec, calculated by the equation V_spec=V_matrix/(t_tube+(4*t_fin)), exceeds a lower limit value of 0.140 m². The heating/air-conditioning device is particularly suited for use in the air conditioning of the passenger cab of passenger vehicles below 2000 kg empty weight within a vehicle platform comprising more than 50,000 vehicles per year, wherein the air conditioning can be performed using the exhaust heat of the liquid-cooled driving engine and/or its components or other heat sources of the cooling and/or heating circuit.

Alternatively, a special refinement of the system provides that the total heat efficiency Phi according to the above definition and at the above characterized operating temperatures of −20° air inlet temperature and +50° coolant inlet temperature at a travelling speed profile according to MVEGA is maintained above 80% in all travelling speeds including the idling speed, without an air-side auxiliary heater.

In view of the heat losses in the heating device, these requirements in heating devices typical for passenger vehicles call for an extremely powerful heat exchanger of the invention having an increased installation space. If the cooling circuit is appropriately adapted with regard to the configuration of the coolant lines and with regard to the flow rate and if these important points are satisfied, the PTC auxiliary heater as found today in a great number of Diesel vehicles can be saved, thus not only saving production costs, but also fuel at an amount of 0.5-1.01/100 km compared to an operation with a PTC auxiliary heater and with the same heating performance.

In general, the heating/air-conditioning device according to the invention is cost-efficient if the Diesel vehicles of a vehicle platform are considered isolated, and also if both Diesel and Otto vehicles are equipped with an identical heating/air-conditioning device and the common costs in the vehicle platform are considered. This is particularly advantageous with regard to equal parts strategies within vehicle platforms and partly also beyond the platform limits. Alone from the aspect of costs, all the technologies known on the market for saving PTC auxiliary heaters cannot compete in any way, not to mention the fuel consumption. In the case of a heating/air-conditioning device which is the same for Otto and Diesel vehicles, a “best in class” heating performance in vehicles equipped with an Otto engine is a welcome additional advantage, despite the overall cost advantages for the overall platform.

Accordingly, a widely spread problem is thus surprisingly solved for the first time by this invention. Having regard to the general trend toward smaller heating/air-conditioning devices and a smaller installation space for the heat exchanger and toward engines producing increasingly less exhaust heat for heating purposes, it seems on the first sight that abandoning the installation space for the PTC auxiliary heater, which is considered as a particularly cost-efficient means for satisfying the heating requirements, and instead using a supposedly oversized heat exchanger utilizing the PTC installation space and the installation space efficiency, is not the right way to reach the goal, especially if one considers the additional costs for the most up to date manufacturing technologies for soldered heat exchangers. But in contrary to the general opinion of experts, the modification of series vehicles for the heat exchanger according to the invention and for the heating/air-conditioning device according to the invention shows that the heating/air-conditioning device of the invention is very well capable of delivering a heating power which is the same as that of modern series vehicles equipped with expensive PTC auxiliary heaters, provided that the coolant circuit and the local flow rates through the heat exchanger as well as the remaining heat sources and heat sinks in the motor cooling system are suitably adapted. Measurements in the climate wind tunnel and on the road have proved not only a sufficient cab heating performance, but also fuel savings, which up to present have not been believed being possible, and a reduction of the costs for the heating/air-conditioning device.

Decisive for the step toward the heating/air-conditioning device according to the invention is the surprising knowledge that the PTC auxiliary heater can in fact be omitted, because only then it is possible to gain the installation space required for the supposedly oversized heat exchanger in existing vehicle concepts. According to the invention, this installation space can be utilized to make the heat exchanger even more efficient. The higher construction depth in the air flow direction selectively allows a certain reduction of the coolant-side pressure loss and coupled to it a somewhat higher coolant flow rate, but in most applications it preferably allows secondary measures making the flow more uniform to obtain a particularly uniform charging of the heat exchanger with the coolant and/or an increase in the flow rate into the heat exchanger to improve the coolant-side heat transfer and/or if required the changeover to the particularly efficient cross-counterflow construction. However, in many applications it will be the most effective way to work with coolant flow rates through the heat exchanger which are lower than that of the today's series standard. In this context, it must be pointed out particularly to the advantages in the heating performance which are frequently obtained if the thermal spread of the coolant at the heat exchanger and possibly also at the engine is increased by reducing the coolant flow rate through the engine and/or the heat exchanger without any important loss of efficiency of the heat exchanger.

Due to its high efficiency and if necessary also by a further reduction of the return temperature of the heating through measures limiting the coolant flow rate, a heating/air-conditioning device according to the invention including a high-performance heat exchanger will lead to the coolant, the motor components and frequently also the motor oil being less strongly heated up—on average over the entire system - than in a conventional heating device having a PTC auxiliary heater and with the amount of heat dissipated into the cab air being the same. Due to smaller losses of surface heat and to less energy required for heating the thermally active masses, a heating/air-conditioning device according to the invention can provide a considerably improved heating effect.

A particular advantage of the heat exchanger of the invention and the heating/air-conditioning device including an increase in the construction volume of the heat exchanger is that even in a series connection of two or more cross-counterflow stages the pressure provided by conventional motor coolant pumps is sufficient. This is especially true for applications in which the motor can do without a radiator bypass, i.e. without the branch 6b in FIG. 7a, or in which the radiator bypass is kept closed by means of a special radiator thermostat 6fzs instead of the conventional thermostat 6fz or by means of an additional valve 6bv, if the demand for heating is high. In a particularly cost-effective simplification of the system the external flow rate control element 2 and the motor radiator thermostat 6dv are omitted according to FIG. 7b, and instead of the bypass valve 6bv a special thermostat 6fzs is used, said special thermostats being constructed as double-acting thermostats including a bypass control element having its spring deflection extended in such a way that the bypass control element closes the bypass branch 6b in a spring-loaded fashion with the radiator branch in its closed condition. At very high engine speeds the suction pressure of the motor coolant pump 7 opens the bypass branch 6b and provides for sufficient cooling of the motor. In this construction, the coolant flow rate through the heat exchanger is defined by the heat exchanger layout and the coolant piping in connection with the opening characteristic of the bypass spring plate in the special radiator thermostat 6fzs. As in FIG. 7a, a thermostat valve 6tv in FIG. 7b guarantees that the radiator thermostat 6fzs always reliably opens if the coolant temperature is excessively high and also if a great amount of heat is extracted at the heat exchanger. When the radiator branch 6a is fully open, the bypass control element of the special thermostat 6fzs closes the bypass branch 6b in the same way as with conventional thermostats. Incidentally, the motor and vehicle cooling system schematically illustrated in FIG. 7a, b comprises for the motor 1 including the heat exchanger a coolant pump 7, a vehicle radiator 8, an expansion tank 9 and a motor control device 16 which are interconnected by the illustrated passages. Further provided are a motor temperature sensor 15, a motor oil cooler 30 with a thermostat 6dv, and a transmission oil cooler 40 with a thermostat 6ev. The heating/air-conditioning device 45 of the invention includes between the air inlet 21 associated with the heat exchanger 4m and the air outlet 20 an evaporator 51 and a temperature mixing flap 5 upstream of the heat exchanger that can be bypassed by a bypass 22 for the adjustment of the mixing temperature.

At low rotational speeds of the motor and at coolant temperatures lower than the thermostat opening temperatures of the special radiator thermostats 6fzs and the auxiliary thermostat valve 6tv, i.e. when the branches 4b, 6a and 6b are closed, this approach provides for a certain pressure reserve, so that the heater coolant flow rate during the idling speed of typically 800-100 rpm⁻¹ or in the range close to the idling speed (e.g. at engine speeds which are up to 10% or up to 15-20% or up to 25-50% above the idling speed) will substantially not decrease or not decrease all-too much. This quite considerably enlarges the scope for the layout of the heat transfer-increasing structural measures at the heat exchanger and also for the increase of the thermal spread both at the heat exchanger and the motor including the effective utilization of the motor oil cooler for thermal heat generation. The physical interactions that are part of this particularly effective and very inexpensive overall system including the special thermostat 6fzs are already described in detail in earlier patent applications of the same inventor. These earlier patent applications also describe further examples of the piping system with different main foci of the layout.

According to the invention, the soldered high-performance heat exchanger includes fin and/or tube center-to-center distances which are as small as possible. Alternatively or additionally the heat exchanger has passage heights and/or wall thicknesses of the flat tube coolant passages which are as small as possible, while the heat exchanger in this case has to be constructed as large as possible utilizing if necessary also the allegedly indispensible PTC construction space and no alternative auxiliary heating facilities are provided if necessary.

The heat exchanger according to the invention or the heating/air-conditioning device included therein turned out to be particularly effective in large-scale applications in passenger vehicles below 2000 kg empty weight. The term large-scale means an annual production of more than 50,000 vehicles per year which all contain the identical heating device or the identical heat exchanger. In the true volume segment the advantages of the present invention become even more apparent, especially in soldered aluminum heat exchangers.

In contrary to prior art, the approach according to the invention aims on the one side at the use of heat exchangers that are soldered as efficiently as possible regarding the construction space and on the other side at the selection of a heat exchanger volume which is considerably larger than previously at the changeover to soldered aluminum heat exchangers. Contrary to the current approaches of all manufacturers to use particularly small-volume and particularly inexpensive heat exchangers and thus saving costs, the present invention intentionally goes the opposite way using highly efficient soldered heat exchangers, especially made of aluminum, different from the low-efficiency plugged heat exchangers as employed for a long time for example in the VW Golf 2 and 3.

In this context and for a comparison with modern vehicles with typical exponents of soldered heat exchangers FIG. 4 shows a table with some characteristic features for classification. The largest-volume soldered heat exchangers here have a matrix volume of approx 1.5 l or 1.6 l, however with a relatively coarse meshed spacing of the coolant-side flat tubes of approx 9 or 10.5 mm. Especially in the new designs of heat exchangers having particularly small center-to-center tube spacing t_tube and center-to-center fin spacing t_fin the matrix volume in the Golf class partly goes down to values of approx 0.7 l. And even in larger vehicles like BMW 3 and 5 or Mercedes E class the heat exchanger matrix meanwhile only is approx 1 l in view of the manufacturing advances concerning the amelioration of the tubes and fins. The feasibility of a smaller center-to-center tube spacing t_tube simultaneous with smaller center-to-center fin spaces t_fin of the air-side fin system is the decisive reason for the heat exchanger matrix volume being reducible and also practiced passenger vehicle large-scale applications.

The measure V_spec established as the “specific heat exchanger volume” and obtained by the equation V_spec=V_matrix/(t_tube+(4*t_fin)) reflects these facts. This indirectly includes also the fact that it is possible in the meantime technically and economically to use very thin-walled materials for the fins and the tubes and also to realize very small coolant-side passage heights.

The consideration of typical soldered passenger vehicle heat exchangers in FIG. 4 shows that the specific heat exchanger volume V_spec, obtained by the equation V_spec=V_matrix/(t_tube+(4*t_fin)), in typical passenger vehicle large-scale applications does not exceed an upper limit of 0.118 m² and that this value does not exceed 0.122 m² even at the highest value known to the inventor in a heat exchanger installed in a mini-van. If one considers besides the Ford Focus (in which the decisive reason for the size of the heat exchanger are motor-specific reasons due to the basic abandonment of a motor-side radiator bypass 6b in some motors of this vehicle type) the remaining vehicles of the Golf class, one will see that the current large-scale value for the specific heat exchanger volume V_spec is more in the order of 0.07-0.08 m². In the somewhat larger and more expensive vehicles and especially in vehicles with a somewhat higher demand of comfort such as in the Audi A4, BMW 3 and 5 and Mercedes Benz E class, the measure V_spec is somewhat higher with 1.0 l, but clearly below the Ford Focus.

If the air-side fins and the coolant flat tubes are maintained, the approach according to the invention normally results in heat exchangers having a heat exchanger matrix volume which is 1.5 to 2.5 times larger than that of the corresponding presently available heat exchangers. In this context, the FIGS. 5 and 6 once again show how the changeover from a consideration purely of the heat exchanger matrix volume V_matrix according to FIG. 5 to a specific consideration of the heat exchanger matrix having the measure V_spec has to be judged, especially with regard to the large-scale heat exchangers of FIG. 4.

Advantageous further developments are discussed in the Detailed Description below.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic side view showing a typical heating device including a modification according to an embodiment of the invention;

FIG. 2 is a schematic side view similar to FIG. 1 showing an associated installation situation;

FIG. 3 is a schematic view of a soldered heat exchanger of a current passenger vehicle;

FIG. 4 is a Table showing the results of a survey of the dimensions of typical vehicle heat exchangers installed at present in mass production;

FIG. 5 is a bar graph illustrating the changeover with respect to large scale heat exchangers of FIG. 4, based solely on consideration of heat exchanger matrix having the measure V_spec;

FIG. 6 is a bar graph similar to FIG. 5 illustrating consideration of heat exchanger matrix volume;

FIGS. 7a and 7b are schematic flow diagrams of a motor vehicle cooling systems according to embodiments of the invention;

FIG. 8 is a schematic illustration of heat exchanger installation in a cross-counterflow according to an embodiment of the invention;

FIG. 9 is a schematic illustration of heat exchanger installation according to another embodiment of the invention analogous to FIG. 8;

FIG. 10 is a schematic illustration of heat exchanger installation according to a further embodiment of the invention having a bypass valve;

FIG. 11 is a schematic illustration of heat exchanger installation according to an embodiment of the invention with four heat exchanger tubes having 4-stage cross-counterflow;

FIG. 12 is a schematic illustration of heat exchanger installation similar to FIG. 11 and having a flow crossover pipe;

FIG. 13 is a schematic cross sectional view of the heat exchanger installation taken along line A-A of FIG. 12;

FIG. 14 is a schematic diagram illustrating the flow distribution of the heat exchanger installation of FIGS. 12 and 13;

FIG. 15 is a schematic cross sectional view of a heat exchanger installation which is a modification of the heat exchanger of FIG. 13;

FIG. 16 is a is a schematic illustration of heat exchanger installation according to another embodiment of the invention which is a modification of that shown in FIG. 11;

FIG. 17a is a schematic cross sectional view of the heat exchanger installation taken along line A-A of FIG. 16;

FIG. 17b is a schematic cross sectional view similar to FIG. 17a of a modification of a heat exchanger installation;

FIG. 18 is a schematic flow diagram of an embodiment of a plate heat exchanger according to FIG. 17; and

FIGS. 19(a), (b) and (c) are schematic perspective, plan and cross section views of part of a heat exchanger according to an embodiment of the invention.

### DETAILED DESCRIPTION OF THE INVENTION

The matrix volume V_matrix of the heat exchanger according to the invention can be ≧1-1.25 l or ≧1.3-1.4 l, for example ≧1.5-1.75 l or ≧1.8-2.0 l, particularly also ≧2.25-2.5 l. The matrix volume V_matrix can be ≦4-5 l or ≦3-3.5 l, for example ≦3.25-3.0 l or also ≦2.5-2.75 l, without being limited thereto. Preferably, the volume of the heat exchanger matrix is in a range between 1.4 l and 2.5 l.

The center-to-center spacing of the air-side heat exchanger fins t_fin can be ≦2.5-3 mm or ≦1.5-2 mm, particularly ≦1.1-1.25 mm, preferably ≦0.9-1 mm, particularly preferably ≦0.7-0.8 mm. The center-to-center spacing of the air-side heat exchanger fins t_fin can be ≧0.2-0.25 mm, ≧0.3-0.4 mm or ≧0.5-0.6 mm, without being limited thereto. The center-to-center spacing here is the spacing of the fins at the level of their centers, i.e. centrally between opposite tubes. The center-to-center spacing thus corresponds to the length of the finned tube sections divided by the number of fins provided in this section. If the fin spacing varies, e.g. if different tubes or tube sections with different center-to-center fin spaces are provided, reference has to be made to the average center-to-center spacing.

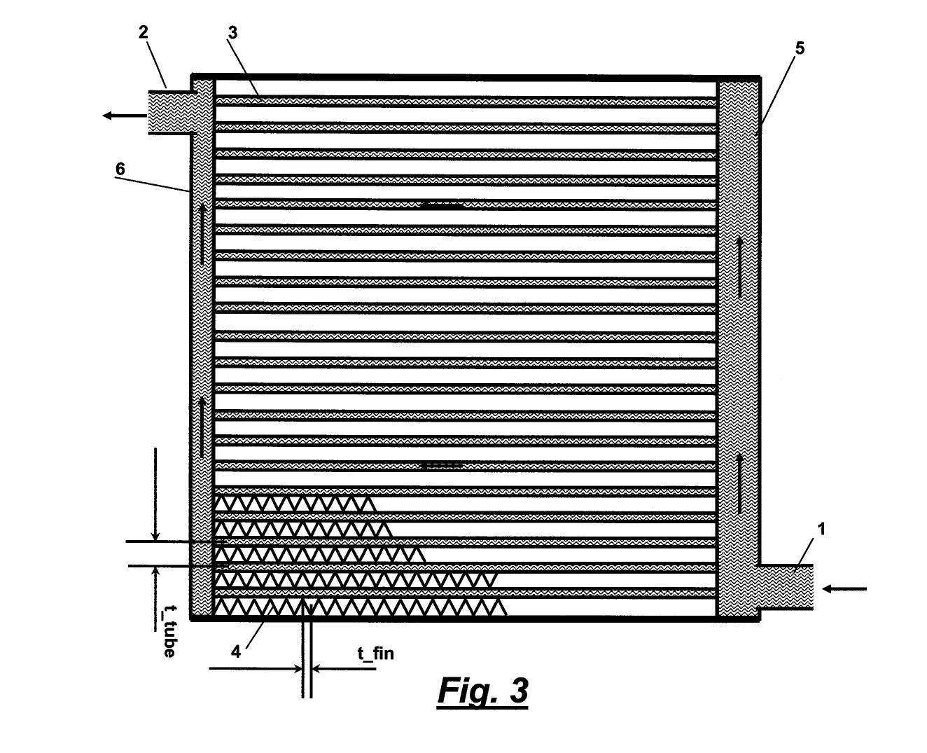

Reference is made to FIG. 3 and the above explanations to this figure.

The center-to-center tube spacing t_tube can be ≦15-17.5 mm, in particular ≦12-13 mm or also ≦11 mm or ≦7-0 mm. The center-to-center tube spacing t_tube can be ≧2-3 mm or ≧4-5 mm, for example ≧5-6 mm or ≧7-8 mm, without being limited thereto. The center-to-center spacing here is the spacing of the tube centers. If the center-to-center tube spacing varies, for example if regions with a different center-to-center tube spacing are provided, reference has to be made to the average center-to-center tube spacing.

The passage height of the coolant-side flat tube-like flow passages can be ≦2.5-2.75 mm or ≦2-2.25 mm, in particular ≦1.75-1.8 mm or also ≦1.5-1.25 mm or ≦1 mm. The passage height can be ≧0.3-0.5 mm or ≧0.6-0.75 mm, for example ≧0.8-0.90 mm, without being limited thereto. The passage height here is the dimension of the tube cross section having the smaller dimension compared to the passage width.

In particular, the center-to-center tube spacing t_tube (if required the average center-to-center tube spacing) of the coolant-side flow passages through which coolant flows can be less than 7 mm and/or the center-to-center spacing of the parallel air-side passages through which air flows (if required the average center-to-center spacing) can be less than 1 mm. It is also possible for the coolant-side flow passages being constructed as flat tube-like passages having a passage height less than 1 mm and/or the center-to-center tube spacing t_tube (if necessary the average center-to-center tube spacing) of the parallel coolant-side flow passages through which coolant flows can be less than 7 mm. It is also possible for the coolant-side flow passages being constructed as flat tube-like passages having a passage height of less than 1 mm and/or the center-to-center spacing (if necessary the average center-to-center spacing) of the parallel air-side heat transmission fins through which air flows can be less than 1 mm. It is also possible for the center-to-center tube spacing, the fin spacing and the passage height being dimensioned in the combination here described.

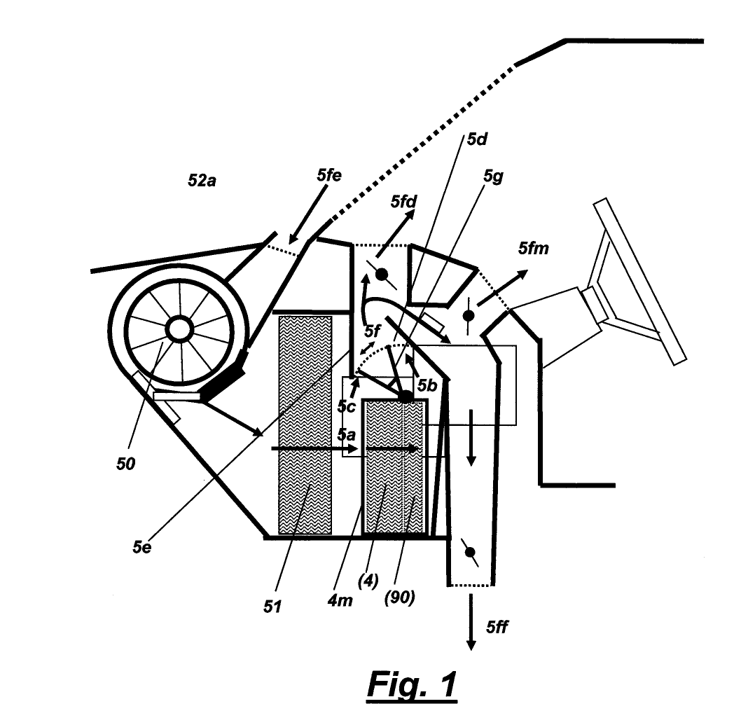

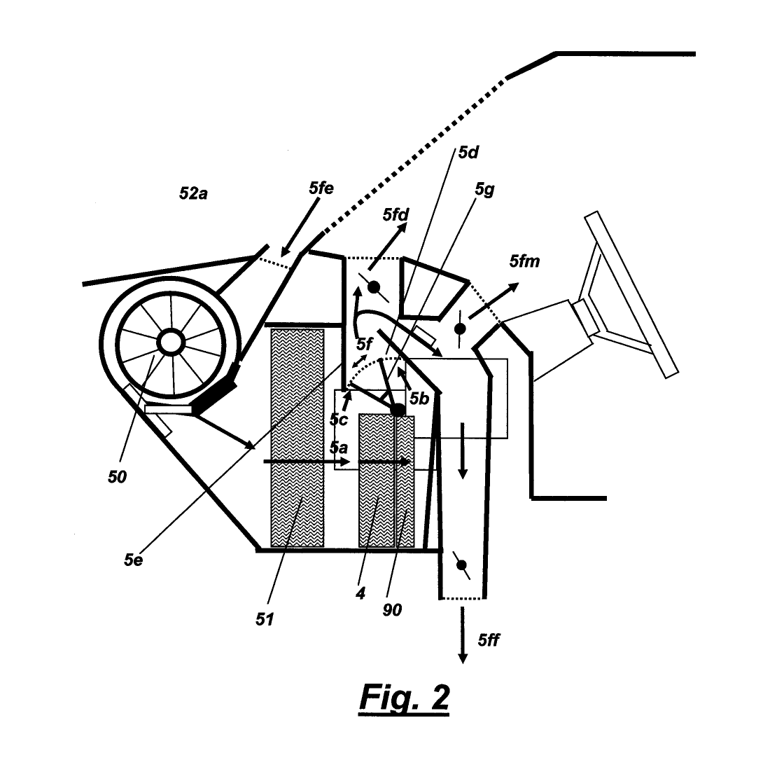

FIG. 1 shows a typical heating device 45 within the system limit 52a as installed today in large-scale passenger vehicles and including the modification according to the invention. In this embodiment a blower 50 sucks in fresh air through the inlet 5fe and passes this air apart from certain leaks essentially fully through the heat exchanger 4m of the invention via the evaporator 51 of the air-conditioner and during the heater operation in the case of a heat deficit, i.e. with the temperature mixing flap 5b/5c in the position for maximal heating. The heat exchanger 4m occupies the volume (4) and (90) of the previous series heat exchanger (4) and the previous series PTC (90). The associated installation situation of the corresponding previous series application is shown in FIG. 2 with the heat exchanger 4 and the electric PTC auxiliary heater 90. If the heating power is set to its maximum, the major part of the air introduced into the cab is directed via the foot vents 5ff. Depending on the vehicle class and the demands concerning the air-conditioning comfort, some of the vehicles are equipped with foot vents only in the front seat area and in vehicles with higher comfort also in the back seat area.

In addition to the air distributed through the foot vents, control flaps, e.g. 5fd, for the windscreen and/or 5fm as so-called dashboard vents allow the adjustment of the air distribution as needed. Additionally, a part of the cab air is normally directed to the vehicle windows to prevent them from fogging-up. In the partial load operation of the heater the temperature mixing flap 5b/5c takes over the throttling of the heater, if required in coordination with a reduction of the blower power. A limit stop 5e for the mixing flap 5b is provided by a panel 5e. Reference number 5a indicates cold air flowing into the heat exchanger, 5f the tempered cab supply air (mixed temperature from flow path 5b and 5c), 5d the heating air path (unmixed air from the heat exchanger) and 5g a temperature control flap.

An important point of the approach according to the invention is that a large-volume heat exchanger 4m as illustrated in FIG. 1 is used, which is much more powerful than previous heat exchangers, and also that no installation space is available or reserved for the PTC auxiliary heater in the direction of flow behind the heat exchanger.

Therefore, the construction volume of the heat exchanger according to the invention can be increased by at least the construction volume of the PTC auxiliary heater, if necessary including the mounting gap between the heat exchanger and the PTC auxiliary heater. A particular advantage is if the heating/air-conditioning device is equipped with a soldered high-performance heat exchanger, preferably made from aluminum, copper or brass and characterized in that the heat exchanger is constructed from at least one stage and preferably from two or more stages, comprising:

a soldered heat exchanger fin-tube matrix in a cross-flow design (as typical in passenger vehicles) with

flat tube-like heat exchanger passages for the liquid coolant and with

air-side flow passages formed by the surfaces of the coolant-side heat exchanger passages facing away from the coolant, and air-side metal fins soldered to them, said metal fins being provided

with a plurality of turbulence-producing recesses (“louvers”) of the air-side heat transfer fins transversely to the air flow.

Such a high-performance heat exchanger preferably has an (average) center-to-center rib spacing t_fin of the parallel flown-through air-side heat transfer fins of less than 1.3 mm or less than 1.15-1.0 mm and/or the (average) center-to-center spacing t_tube of the parallel flown-through coolant-side flow passages is less than 7 mm. Further, it is advantageous to form the coolant-side flow passages as flat tube-like passages having a passage height of less than 1 mm, said height representing the smaller dimension of the passage cross section.

If the marginal conditions of existing production plants lead to limitations that do not allow very thin-walled coolant-side flow passages, it is also possible—with certain restrictions concerning the overall heating potential—to use a matrix with an (average) center-to-center spacing of the air-side heat transfer fins smaller than 0.8 mm. The (average) center-to-center spacing of the parallel flown-through coolant-side flow passages here preferably amounts to 9-11 mm. In such a heat exchanger the coolant-side flow passages are preferably provided as flat tube-like passages having a passage height of 1-2 mm. In this case the matrix volume can at least be 1.7 l or preferably even 2.0 l or more. The greater center-to-center tube spacing and the larger matrix volume are helpful here for keeping the air-side pressure losses in this configuration within reasonable limits. In addition, the larger matrix volume V_matrix and the particularly small fin spacing t_fin compensate certain deficits in the coolant-side heat transfer.

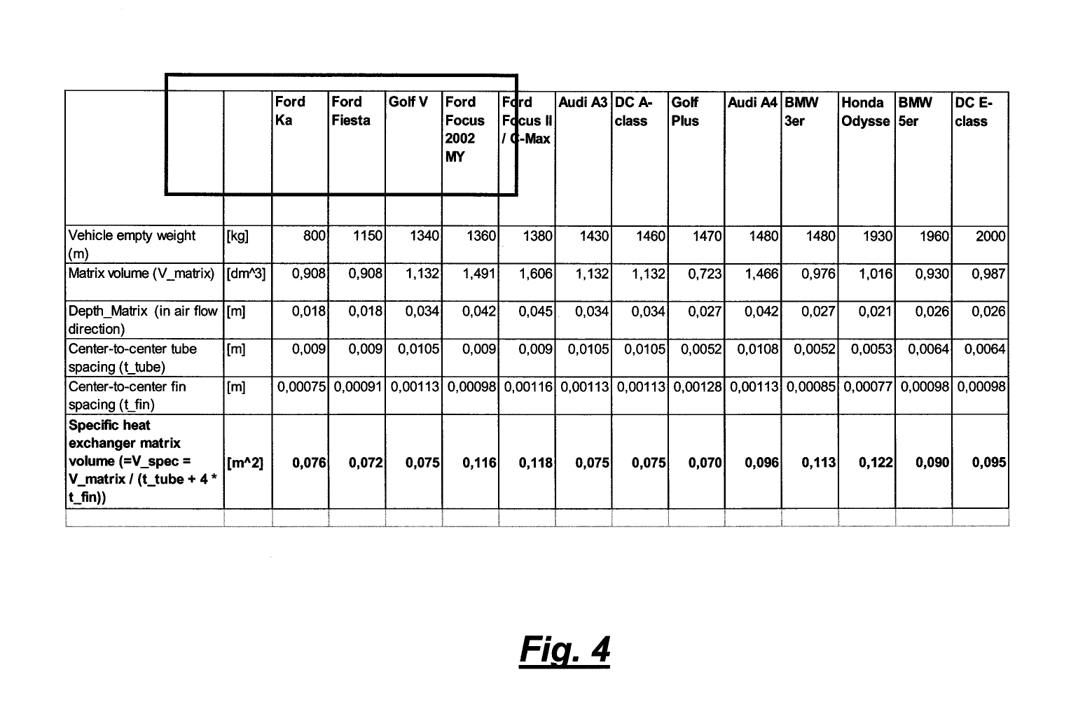

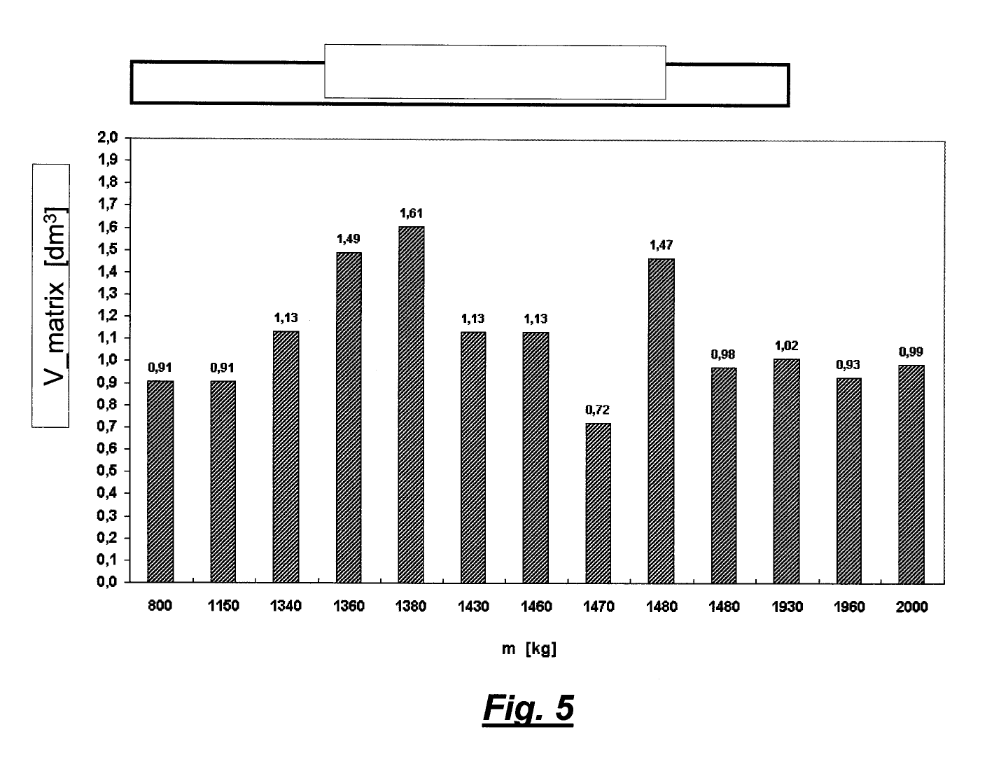

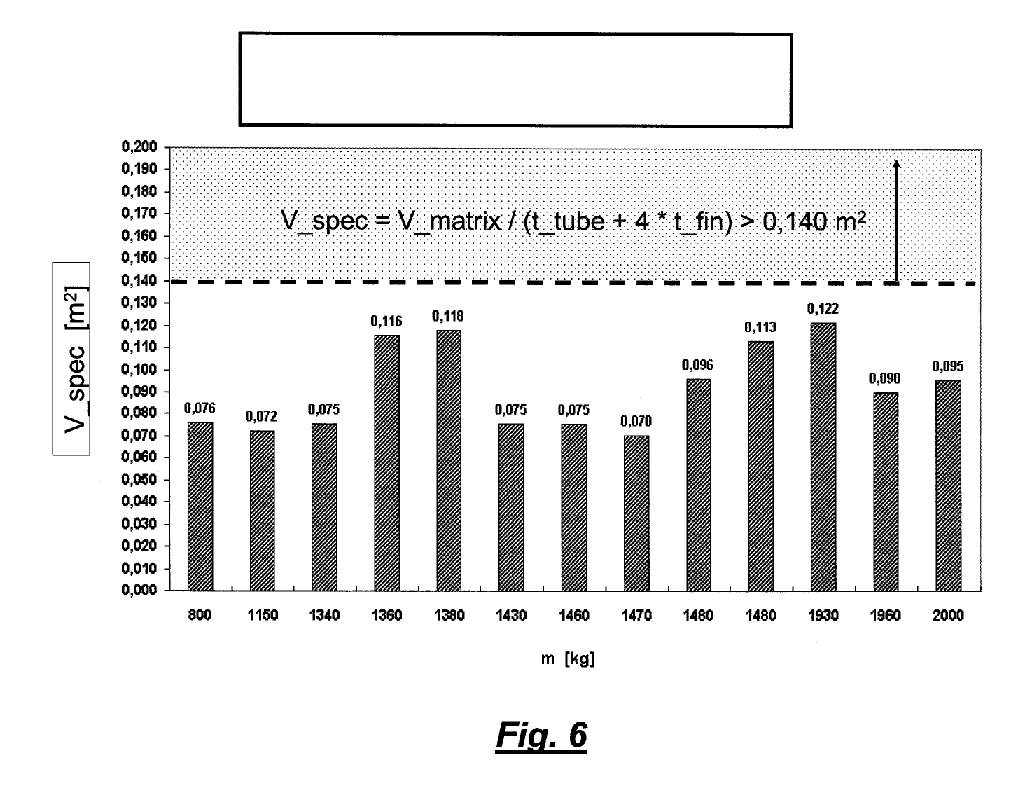

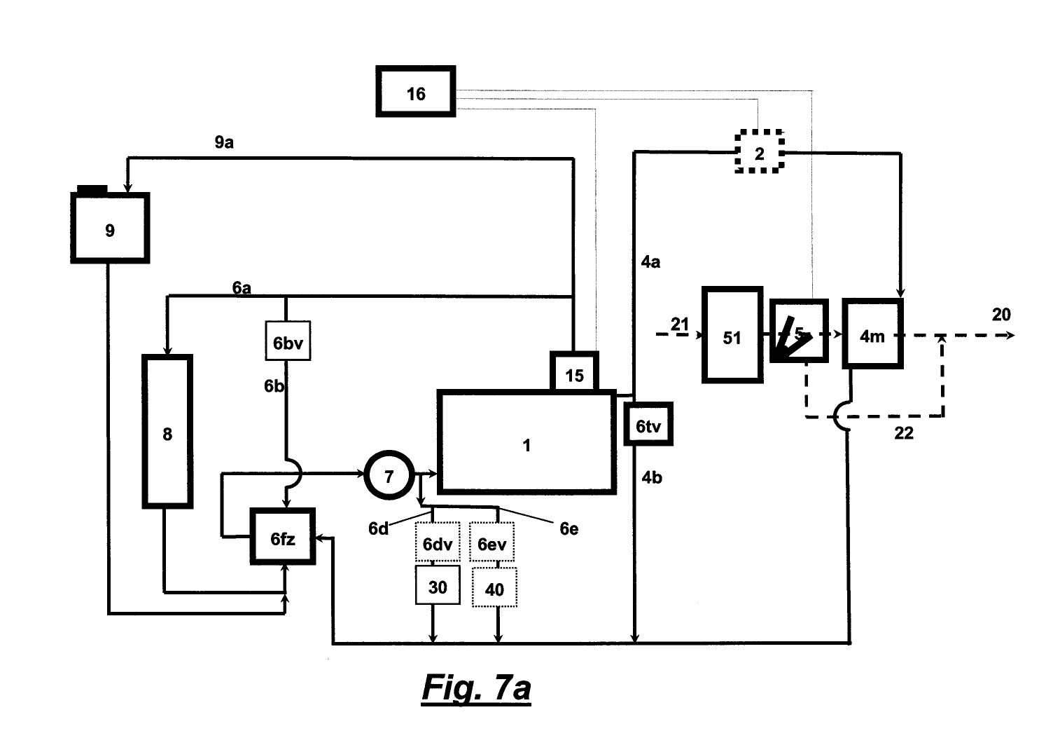

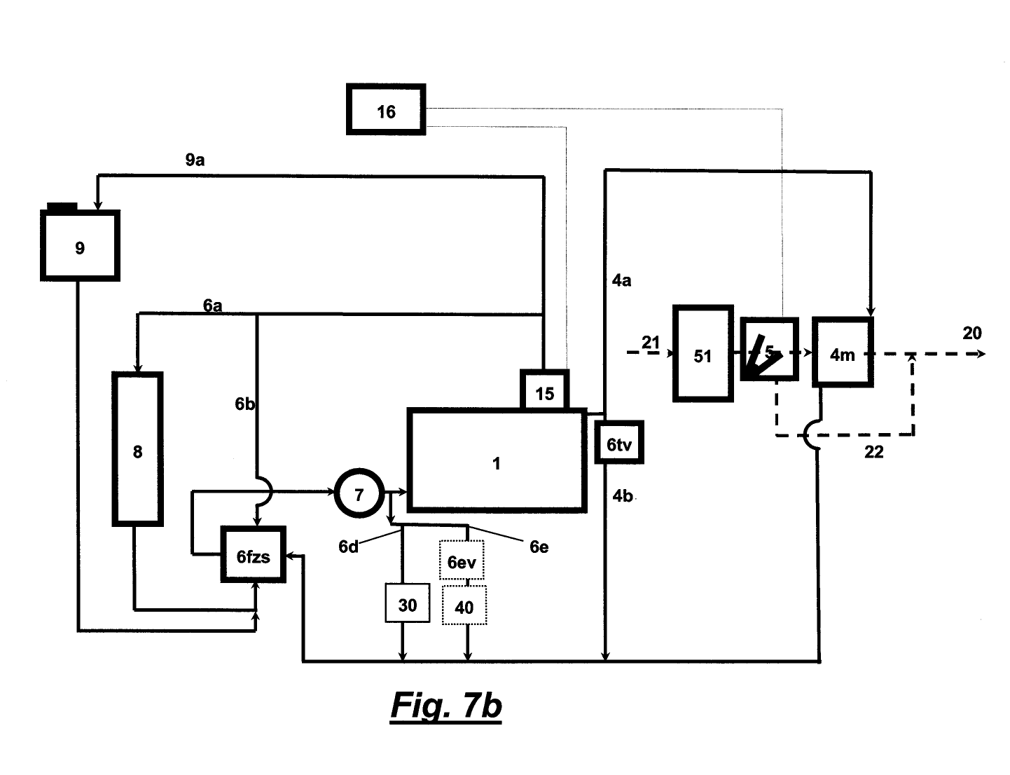

Heat exchangers having a high-performance heat exchanging matrix are basically known, for example in the latest BMW 3 series (for further examples see FIG. 4). New however is the use of the per se known high-performance heat exchanger matrix with a construction volume that by far exceeds the dimensions known up to present, and this although up to present the users always assume that the series heat exchangers are largely operated already at thermal saturation and that any enlargement would thus no make sense and also would not be possible in view of the required PTC installation space. Accordingly, as already mentioned, the strong enlargement of the construction volume in the practice is based on the realization that the approach according to the invention makes it actually possible to dispense with the PTC auxiliary heater. Surprisingly, the heating/air-conditioning device according to the invention can thus dispense with a PTC auxiliary heater. But a further important option of the invention in this context is to accept if necessary a significant increase of the air-side pressure losses at the heat exchanger. In the simplest case the invention provides for keeping the already highly compact heat exchanger matrix of the series heat exchanger and constructing the heat exchanger with a depth increased by the factor 1.5-2.5 or even more in the air flow direction, which means that the matrix volume increases by the factor 1.5-2.5 or more. Despite the omission of the PTC auxiliary heater, the air-side pressure loss at the heat exchanger thus also increases by almost this factor. But practical tests have shown that, contrary to the problems expected at the first sight in connection with the air flow rate, this is in many cases educible. Of course, in new vehicle developments the width or the height of the matrix can be utilized among others for the matrix volume enlargement according to the invention.

The increase of the matrix construction depth in the air flow direction as provided by the invention opens in a third step a broad field for optimally adapting the coolant-side pressure loss or the coolant flow rate of the heat exchanger to the respective case of application. This is principally of high interest particularly for the incorporation of measures for making the coolant flow through the heat exchanger tube across the heat exchanger width more uniform, and also for the changeover to the highly efficient cross-counterflow design with two or more stages.

Q 100 is a good assessment method for delimiting particularly effective embodiments of the heating device of the invention including a high-power heat exchanger against prior art. The Q 100 standard describes the power output of the heat exchanger during flow-through at a temperature difference of 100 K between the coolant inlet temperature and the air inlet temperature. Satisfactory passenger vehicle heat exchangers today achieve a Q 100 standard of approx 8.0-9.0 kW at a mass air flow of 6 kg/min and a mass coolant flow of 10 l/min at 50/50 vol.-/% of water/glycol. If one considers the passenger vehicle heat exchangers available on the market, with the highest output per matrix volume up to the upper middle class—the heat exchanger matrix volume thereof being approx 0.72-1.1 l, the maximum output by volume of modem high-performance passenger vehicle heat exchangers in connection with the above Q 100 standards of 8.0-9.0 kW is approx 11 12.5 kW/l of heat exchanger matrix. Against this background the volume enlargement for example of the heat exchanger matrix according to the invention from e.g. 1.0 l to more than 1.4 l means a deliberate reduction of the specific power to values clearly below 7.1 kW/l (=10.0 kW/1.4 l), for example to ≦6.7-6.85 kW/l, ≦6.5-6 kW/l or also ≦4.5 -5 kW/l. The specific power can be ≧2-2.5 kW/l or ≧2.75-3 kW/l, for example ≧3.5-3.75 kW/l or ≧4 kW/l.

A series connection of two or more high-performance cross-flow heat exchangers in the cross-counterflow, which is particularly preferred in the present invention, means in this connection that single cross-flow heat exchangers each having an individual power per volume of more than 8-9 kW/l are intentionally reduced as explained above by the series connection and despite the cross-counterflow operation to less than 7.1 kW/l. In the practice this reduction of the specific power is even higher, among others because of the compromises that have to be made in some applications with regard to the air-side fin spacing for keeping the air-side pressure losses of the heat exchangers of the invention within limits.

Although the technique according to the invention primarily aims at the complete omission of the PTC auxiliary heater, even a technique is normally conceivable providing the enlargement of the specific matrix volume V_spec in connection with an electric PTC auxiliary heater according to the invention. In this context it is of course important ro reserve a sufficiently large installation space, although this might be practicable only in very exceptional cases. The original object then changes toward limiting the PTC operation to an electric power or duty factor which is as low as possible and thus to an additional fuel consumption due to the PTC which is as low as possible and/or toward restricting the PTC installation to cold countries and/or to sparing additional costs for larger generators due to the PTC.

However, the technique according to the invention provides maximum benefit only if the PTC disappears from all applications of the vehicle series, so that the heating/air-conditioning device according to the invention doesn't need any provisions with regard to a reserved installation space or fixing devices or electric connections for an air-side PTC auxiliary heater or any other auxiliary heater in the heating/air-conditioning device.

The heating/air-conditioning device according to the invention is particularly efficient if the high-performance heat exchanger is constructed from at least two and preferably three or four cross-flow heat exchangers in cross-counterflow. In this context, it is particularly advantageous if the coolant, before its transfer from one stage of the heat exchanger to the next, is mixed by means of cross-sectional constrictions and is thus also throttled to a certain extent. This measure has a particularly positive effect on the start-up of the heat exchanger when the coolant is very cold or if air supply takes place non-uniformly, since in this way each individual stage exhibits more homogeneous coolant inlet temperatures across the width of the water tank. Inhomogeneities in the coolant temperature are less increased from stage to stage in the cross-counterflow operation, since an evasion of the coolant flow to the passages having a higher coolant temperature or a lower coolant viscosity is less strongly induced. The throttle effect of this measure is a welcome side effect in many applications, because it increases the coolant temperature spread at the heat exchanger and possibly also at the motor, thus improving the heating if the heat exchanger is sufficiently dimensioned.

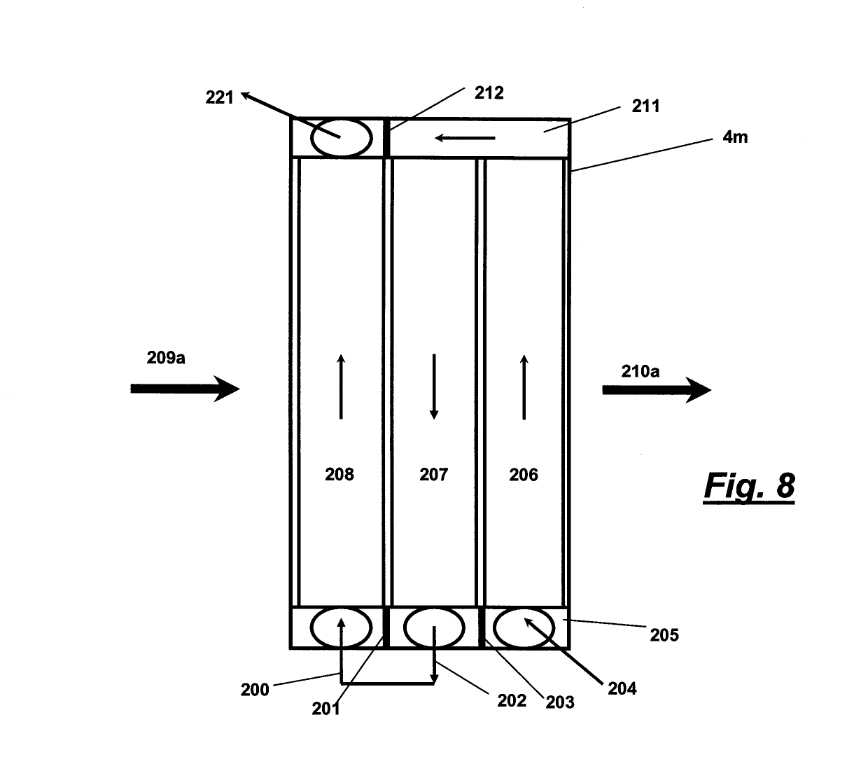

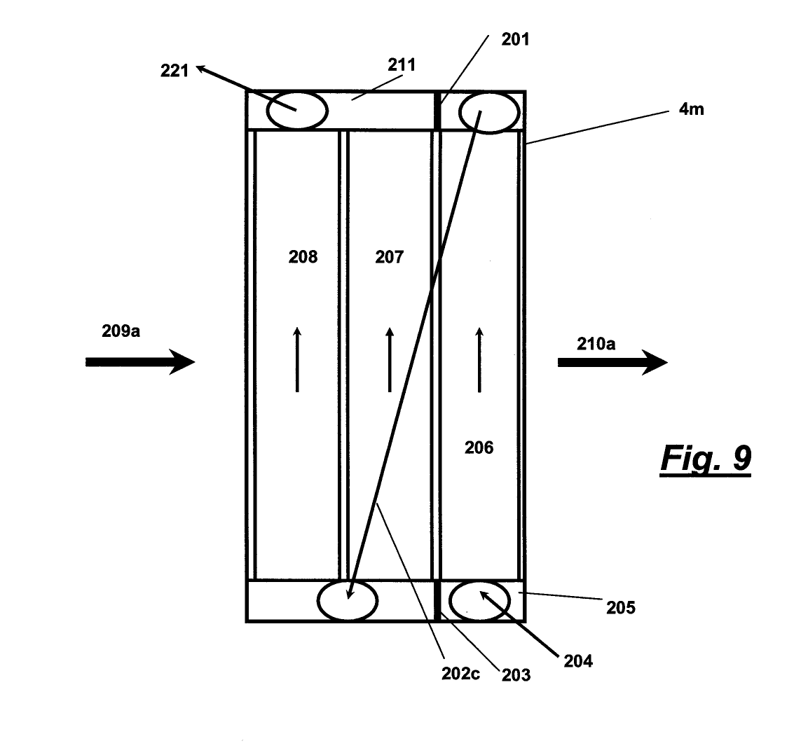

This thorough mixing can take place in a particularly efficient and simple way by conducting the entire coolant volume of a first water tank trough a common bore or a common connecting passage to the subsequent water tank of the next stage. FIG. 8 illustrates a correspondingly constructed heat exchanger in a cross-counterflow. Here the coolant inflow takes place through the inlet 204, and the first cross-flow stage is formed by the series of flat tubes 206, with a first conventional redirection to the second cross-flow stage 207 in the water tank 211. The transition from the second to the third cross-flow stage 208 takes place via an external connecting passage 202/200 in which thorough mixing and thus thermal smoothing of the coolant necessarily takes place before the third stage, but this can normally take place independently of the embodiment before the third or prior the ultimate stage. The mixing position can also be incorporated in the water tank, e.g. via one or more panels or changes of the flow direction. This can generally apply independent of the embodiment. It is particularly preferable for the temperature smoothing of the coolant largely taking place before the third stage or normally before the ultimate stage. Depending on the installation position and the need for venting, a possible additional vent bore in at least one or in more than one or in all water tank partition sheets, for example in the water tank partition sheets 212 and/or 203/201, provides for a reliable operation. The arrows 209a, 210a in the figures indicate the inflow and outflow directions of the cooling air. An analogous technique is illustrated in FIG. 9 in which the passage 202c takes over the mixing function by conducting the coolant of the first cross-flow stage 206 to the two parallel arranged series of tubes 207 and 208 of the second or ultimate cross-flow stage. This can generally apply independent of the embodiment.

The installation of heat exchangers according to FIG. 8 or FIG. 9 preferably takes place horizontally (i.e. with the heat exchanger tubes horizontally arranged in the installation position), which can generally apply independent of the embodiment, with the coolant inflow 204 being at the bottom. Independent hereof the installation can take place generally with the heat exchanger tubes in a vertical position (upright heat exchanger tubes 206, 207 and 208).

A particular advantage of the illustrated construction is that the horizontal or vertical installation allows the heat transfer tubes of the heat exchanger being arranged parallel to the travelling direction of the respective vehicle. This results in a more uniform through-flow of the coolant in the particularly important setting to maximum heating in the foot space position. In the preferred installation position the outlet water tank or the coolant outlet 221 is positioned at the top relative to the installation position and with the heat transfer tubes 206, 207, 208 in the upright position.

A pressure loss which is somewhat lower than that of a single cross-over piping 202 is achieved by a technique in which mixing takes place by conducting the coolant volume of a first water tank through precisely two bores or precisely two connecting passages to the subsequent water tank of the next stage and in which a partition sheet in the water tank separates the two flow paths.

To save a coolant-side pressure loss, the mixing in FIG. 8 takes place only at the transition to the ultimate and thus coldest stage on the coolant side. This can generally apply independent of the embodiment. Since the ultimate, i.e. coldest stage reacts the most sensitively to temperature inhomogeneities at the inlet of the individual parallel coolant passages, the mixing according to the invention is particularly effective here and is beneficial also to the more downstream stages on the air side due to the particularly homogeneous air outlet temperatures.

The heating device according to the invention provides for an improved heating power in almost all applications. But depending on the motor, even additional measures on the side of the cooling system can be used to achieve a heating power which is the same as that of the today's PTC auxiliary heater in almost all operation situations. It is especially advantageous for the cooling and heating system being designed in such a manner that the main coolant flow for cooling a combustion engine in a first operation mode with less exhaust heat of less than 5 kW (if necessary also less than 10 kW or less than 20 kW) dissipated into the coolant primarily passes through the heat exchanger, while in a second operation mode with a comparatively higher exhaust heat and/or with coolant temperatures of 10 K (if necessary 15 K or 20 K) above the temperature of earliest opening of the vehicle radiator branch settable or thermostatically preset in the vehicle, said main coolant flow also passes through a vehicle radiator and/or a radiator bypass and that in this second operation mode in the speed range close to the idling speed of the combustion engine less than 2.5-2.25 l/min, e.g. less than 2.0-1.8 l/min of the coolant flow through the heat exchanger even at a high to maximum cab heating demand. The speed close to the idling speed can for instance be up to 10% or up to 15-20% or up to 25-50% above the idling speed of typically 800 to 1000 rpm. The exhaust heat in the second operation mode can amount to ≧25-50% or ≧100-150% or ≧200% of the exhaust heat in the first operation mode. A cooling system which is designed in this way again indeed contradicts the design guidelines of modern vehicles having a combustion engine, since in conventional heat exchangers and at a heater coolant flow rate of less than 2-3 l/min the efficiency of the heat exchanger drops and in many cases behaves completely undefined. However, in the heating/air-conditioning device according to the invention this acceptable in view of the power reserves of the heat exchanger. A system designed in this way deliver sufficient heating power in the second operation mode, since the thermostat only opens from a relatively high temperature. In the first operation mode, especially in the idling speed, an increased temperature spread is evident enabling the motor or the motor oil being temporarily utilized as an additional heat source for somewhat increasing the coolant temperature at the motor outlet and for minimizing surface heat losses in this operation situation which particularly critical concerning the heating power.

The particular aim of the embodiment according to the invention is to operate the heat exchanger closely to the thermodynamically maximum possible efficiency in a vast operation range of the motor and in a vast operation range of the coolant flows through the heat exchanger, to provide sufficient heating power by reducing the surface heat losses and by saving heating power for heating the components coming into contact with the coolant and the motor oil, and to save fuel by the omission of the electric power for the PTC auxiliary heater. For maximizing the degree of heat efficiency at the heat exchanger and in the heating device it is particularly advantageous to minimize also the losses on the side of the heating device which are caused by the fact that during air-side temperature control a certain part of the cab air does not flow through the heat exchanger matrix, but through leaks of the closed temperature control flaps of the heating device. In view of this it is very helpful, especially if the heating/air-conditioning device includes an air-side temperature control, to guarantee by means of highly effective sealing surfaces on the individual control flaps and/or by means of particularly high pressure forces exerted by their servo motors or other suitable forms of temperature control that, if the heater is fully open, more than 95% of the air supplied to the cab passes the heat exchanger matrix. In this context, minimizing the amount of escaping air guarantees that the advantages of the heat exchanger according to the invention are not unnecessarily limited.

A vehicle in which the heating/air-conditioning device is designed in accordance with the invention will be able to deliver the same heating power as modern vehicles equipped with fuel-intensive PTC auxiliary heaters, if the motor cooling circuit is appropriately designed. With the characteristic marginal conditions of a winter heating test, conducted for example in accordance with the VDA guidelines, a satisfying heating performance will be achieved even if the motor coolant remains colder than in the modern PTC operation. A particularly advantageous tuning of the overall system of the invention can be seen in many applications by the fact that the heating/air-conditioning device in a passenger vehicle with Diesel engine does not include a PTC auxiliary heater or any other air-side auxiliary heater and does not exceed during the first 30 minutes a coolant temperature of 50° C. at the heat exchanger inlet in a typical winter test constant ride in accordance with the VDA guideline, at

50 km/h in the gear stage automatically set by the automatic transmission or, in a manual transmission, in the highest gear allowing smooth travelling,

−20° C. ambient temperature and

a setting of the heater to maximum heating in accordance with the operation manual.

Moreover, a tuning will be advantageous in many cases in which during the first 30 minutes a cooling temperature of 40° C. at the heat exchanger is not exceeded, so that additional heat is saved by the thermal spread at the heat exchanger.

Particularly, in the idling speed the high heat extraction at the heat exchanger and the tuning for a relatively high thermal spread at the heat exchanger will lead to the coolant temperature at the heat exchanger even dropping to below 25° C. after additional 15 minutes of idle running of the motor with the vehicle in the stationary condition, immediately after the first 30 minutes of the heating test conducted at −20° C. and 50 km/h in accordance with the above explanation, yet delivering a heating power which is almost the same as that delivered by modern vehicles with the PTC in operation.

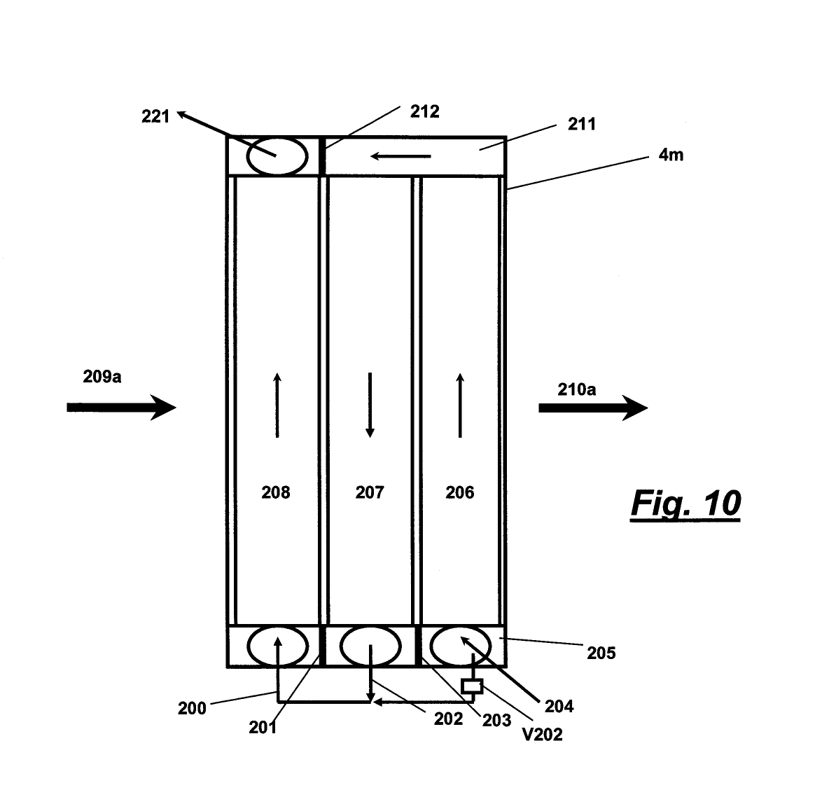

The technique according to the invention providing for a considerable increase of the heat exchanger volume enables using heat exchangers with several series-connected cross-flow heat exchangers in the cross-counterflow and yet with very small passage heights of the flat tubes of the heat exchanger. At low temperatures a certain delay in the thermal start-up, i.e. a certain delay until the heating circuit is filled with partly heated coolant, can be recognized to some extent due to the series connection and the small passage heights. To accelerate this thermal start-up it is particularly advantageous if a valve, especially a valve that opens above a certain pressure difference, temporarily or completely bypasses one or all cross-flow heat exchanger stages at extremely low coolant temperatures. A corresponding valve V202 in a heat exchanger according to the invention is shown in FIG. 10.

In this context it is particularly favorable for the heating/air-conditioning device being configured or operated in such a manner that in the bypass operation the heat exchanger stage(s) facing the cold air inlet is(are) subject to a warm coolant, the coolant being heated through the air in the air-side subsequent stage(s), so that this(these) heat exchanger stage(s) can be gradually increasingly flown-through due to the decreasing viscosity of the coolant.

It has been mentioned already that frequently it is very advantageous for the technique according to the invention leaving the previous specifications in the specification book for heating/air-conditioning devices as far as the coolant flow rate or the air flow rate are concerned and instead allowing higher pressure losses at the heat exchanger. This applies to both the air side and the coolant side. Generally and especially in motors that react positively to a large thermal spread, it frequently is an advantage to design already the heat exchanger in such a way that compared to the today's standards for soldered heat exchangers the same does not produce coolant-side pressure losses in the range of 7-25 mbar at 5 l/min and 80° C. coolant flow rate, but more than 40 mbar or more than 45-50 mbar. Although an increase of the construction volume or the construction depth as provided by the invention promotes in principle the reduction of the coolant-side pressure loss which seems attractive at the first sight, it frequently is much better in such motors to invest the pressure potential in an improvement of the coolant-side heat transfer. This can be implemented among others through a reduction of the coolant passage height of the heat exchanger tubes or through a reduction of the number of cross-counterflow stages or merely through pressure loss-increasing measures that provide for a uniform flow of the coolant through the heat exchanger tubes.

Just as on the water side, the practical test on the air side also shows that an air-side increase of the pressure loss up to a factor 2 at the heat exchanger according to the invention is no problem to cope with compare to today's large scale examples. On the one side this is especially due to that the heat exchanger is responsible only for a comparatively small share of the total pressure loss on the air side and on the other side that a minor drop of the mass air flow frequently shifts the heat exchanger to a more favorable zone of the heat efficiency Phi and additionally also reduces the heat losses caused by partially heated cab air flowing out from the interior of the vehicle. In view of this it not only turned out to be feasible, but in many cases also to be particularly favorable even in a highly compact heat exchanger matrix, i.e. particularly with a center-to-center tube spacing t_tube of below 6-7 mm or below 5 mm, to select a construction depth of the heat exchanger matrix in the air flow direction of more than 48-52 mm, particularly up to 56-60 mm and more and/or to allow an isothermal air-side pressure loss at the heat exchanger of more than 200 Pa or more than 225-250 Pa at 6 kg/min air of 25° C. Compared especially with the highly compact variants of large-scale heat exchangers according to FIG. 4, this means both a quite considerable increase of the construction depth—the greatest matrix construction depth in the air flow direction in the variants with less than 7 mm center-to-center tube spacing there being 27 mm—and also a quite considerable increase of the pressure loss on the air side. But at the installation of a prototype of the heating device according to the invention in modern large-scale passenger cars this turned out to be quite advantageous.

The manufacture of a heat exchanger according to the invention is relatively easy in view of the above explanation, since tools and semi-finished products which are already tested in the large-scale production can be used for the flat tubes of the heat exchanger, for the air-side fins and also for the joining or soldering process. But for a particularly fast series production launch, a method using heat exchangers already produced on a large scale is particularly advantageous. In this case, the installation space gained through the omission of the PTC makes it possible in some vehicles to use two or more at least largely structurally identical single heat exchangers which are connected in series in the cross-counterflow. It is also possible to use existing heat exchangers which are already produced on a large scale. In the simplest case, two highly compact, soldered heat exchangers are connected in series via the coolant supply and discharge passages or via an adaption of the water tank. The small construction depth in the air flow direction of some highly compact heat exchangers allows this approach also in today's heating devices with only a few modifications on the heating device, provided that the PTC auxiliary heater is dispensed with. If a suitable heat exchanger is selected and if the water tank is slightly modified if necessary, three or even more cross-counterflow stage can be realized at a moderate effort.

The technique according to the invention can be principally applied to vehicles with or without a radiator bypass branch 6b.

The heating/air-conditioning device can be assigned to or installed in a vehicle model range comprising 50,000 vehicles per year, all motors of this vehicle motor range including a bypass branch 6b and a motor cooling circuit with a thermostat which is adapted in such a manner that the bypass branch 6b provides a coolant flow rate higher than the heater coolant flow rate at an engine output of ≧50% or ≧70% of the power rating and with the thermostats in the closed state.

In a case without a bypass branch 6b care has to be taken that in the closed state of the radiator branch 6a a sufficient amount of coolant flows through the motor to avoid on the one side a local overheating of the motor at an increased motor load and on the other side to guarantee correct control of the radiator thermostat during the thermostat opening operation. In view of this it is particularly advantageous without a bypass branch 6b to design the heat exchanger branch for the higher flow rate and/or to provide a constantly open branch parallel to the heat exchanger an at least in a heated condition of the motor. Normally in this case the heat exchanger according to the invention will be preferably provided with still some more construction volume and designed for a higher heater coolant flow rate.

Further, there is a need for improving the efficiency of heat exchangers according to the invention and/or of heating/air-conditioning devices with a low to medium coolant flow rate, thus enlarging the scope of dimensioning with regard to the maximum possible increase of the heating power and/or reducing the air-side pressure loss and/or the heat exchanger construction space.

To this end an improvement of the high-performance heat exchanger is proposed, comprising or consisting of

a soldered heat transfer matrix consisting of coolant-side flat tubes and air-side fins with a plurality of recesses following one after the other in the air flow direction and producing turbulences,

precisely four cross-flow heat exchangers connected in series in the cross-counterflow and

on the first coolant-side tube end of the heat exchanger matrix a connecting water tank 301 having a coolant supply connection 311 and discharge connection 312, said connecting water tank being divided by two partitions 350 and 352 for establishing the cross-counterflow, and

on the second coolant-side tube end of the heat exchanger matrix a redirection water tank 300 with precisely one partition 360 defining the four-stage configuration. and wherein

alternatively or in combination

(1) the redirection water tank 300 includes a coolant-side construction height hu which is less than 30% of the coolant-side construction height ho of the connecting water tank 301 and/or

(2) an additional central partition 351 of the connecting water tank 301 with a panel-like flow cross-over 313 between stage 2 and stage 3 is provided, in which the coolant cooled in the first two stages is throttled and simultaneously further homogenized.

Further, a heating/air-conditioning device of a passenger vehicle can comprise such a heat exchanger, and vehicle platform with more than 50,000 vehicles per year, each of which preferably having an empty weight of less than 2000 kg, can be equipped with such a heat exchanger. The above statements of the invention explicitly also relate to this improvement, but the heat exchanger according to this improvement can be used in an advantageous manner also independently.

The improvement of the heating power that can be implemented in this way frequently leads to values of heating power of vehicles better than those obtained with modern PTC auxiliary heaters, so that the new heat exchanger design can be utilized for further decreasing the air-side pressure losses or for further reducing the installation space. Further, these additional improvements can be implemented at minimal costs. With the design according to the invention which is accompanied by the increase of the coolant-side pressure losses a certain drop of the coolant flow rate in the heating branch is connected which significantly contributes to the improvement of the overall system, i.e. to the improvement of the effective heating power of the vehicle.

The redirection water tank can have a coolant-side construction height hu such that the distance between the coolant flat tube exit and entrance and the facing inner wall side of the redirection water tank is exactly the same for each single flat tube, the average distance to the inner wall side of the redirection water tank being less than 1-3 mm for all flat tube end positions along the flat tube circumference.

Further, the flow crossover cross section can have a cross sectional area of flow which is smaller than or equal to the smallest cross sectional area of flow of the inlet connection.

The heating/air-conditioning device can be installed with a heat exchanger which is at least substantially structurally identical concerning the major dimensions. The major dimensions are length, width and height of the device and the heat exchanger. This can generally apply within the scope of the invention.

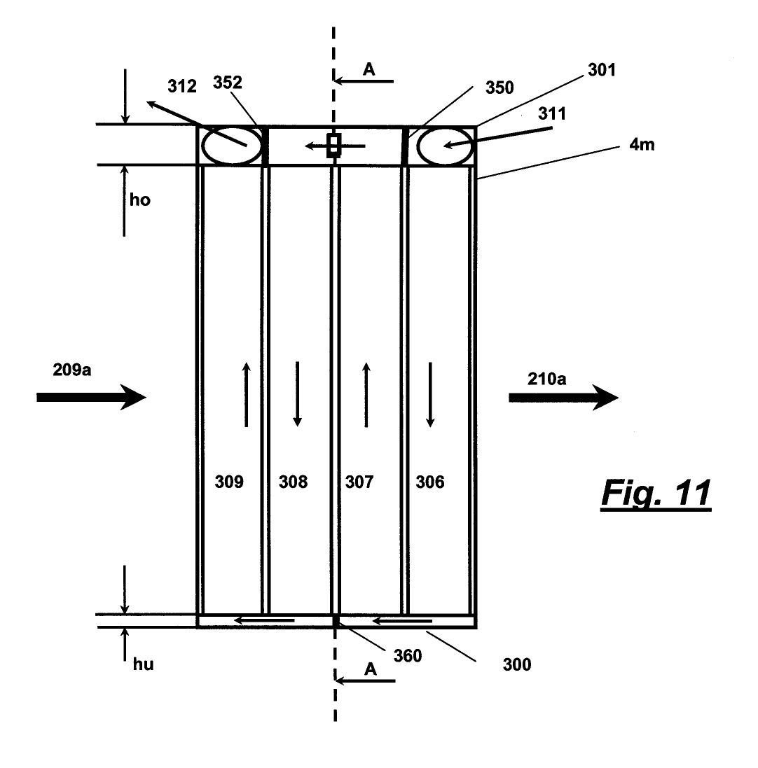

This improvement is shown by way of an example in the FIGS. 11 to 15. The reference numbers 306-309 denote exchanger tubes. Like reference numbers generally have the like denotation, especially in the FIGS. 8 to 15.

In addition to a particularly high efficiency the 4-stage cross-counterflow heat exchangers exhibit also manufacturing advantages compared to 3-stage cross-counterflow heat exchangers. For instance, the redirection water tank 300 can be manufactured more easily and with less tolerance requirements. Particularly important is the possibility to make the redirection water tank smaller and to reduce the construction height hu to very small values, i.e. smaller than 30% of the corresponding dimension ho of the upper connection water tank 301, for example smaller than 25% or smaller than 20% of the same, particularly preferred with less than 1 mm clearance to the opposite water tank wall. Here the construction height relates to the part of the water tank in the partition area of the 1st to the 2nd stage and/or the 3rd to the 4th stage or to the construction height of the overall water tank, i.e. preferably to the construction height over its total extension in the direction of the coolant flow. This enables the provision of additional construction space for the maximization of the heat exchanger matrix volume. The connection water tank here generally comprises the connections for supply and discharge.

The small distance between the coolant flat tube exit and the opposite inner wall of the redirection water tank preferably is less than 1 mm. The small distance of less than 1 mm in context with the connection of the 4-stage configuration and the simple design of the redirection water tank 300 causes particularly small manufacturing and tolerance-specific problems, since keeping a uniform wall spacing necessary for the uniform distribution of flow is required only at the redirection water tank 300, while even rougher tolerances are acceptable at the water tank 301, e.g. at a somewhat different length of the matrix flat tubes.

Contrary to the 2-stage heat exchangers already introduced in the series production of passenger vehicles and compared to water tanks of the conventional size, this measure is suitable for reaching the goal despite the increase of the coolant-side pressure loss associated with this, if the configuration of the overall system—e.g. in accordance with the above described technique according to the invention—goes toward smaller coolant flow rates in the heating branch, i.e. if the heat exchanger itself is used as a throttling element. In this case, the small height ho as well as the quadruple cross-counterflow design and/or the flow crossover position are effective as an internal throttling element in the heat exchanger and simultaneously cause an improvement of the coolant-side uniform distribution of flow and thus an improvement of the heat exchanger efficiency. As important as this effect is the fact that at the same external dimensions of the heat exchanger the small height hu is equivalent to an increase of the matrix front face and also of the matrix volume. Both can be directly translated into a smaller air-side pressure loss and/or into better efficiency.

Compared to typical heat exchangers in modern mass production passenger vehicles with a conventional design of the upper and lower water tanks, the first decisive difference of the this improvement is that four stages are used instead of one or two stages. The layout of system which is untypical for a series production and which aims on the one side to smaller target values of the heater coolant flow rate, but on the other side possibly also to the utilization of the PTC installation space, allow this changeover to four stages without the coolant flow or the heat exchanger efficiency sharply dropping during warmup at a low engine speed.

In addition to the throttling through the four-stage configuration, the redirection water tank 300 is designed as a second additional throttle position in such a manner that the construction height hu of the redirection water tank 300 is less than 30% of the opposite wall of the water tank, as explained above. The small distance to the flow inlet and outlet of the flat tubes relative to the opposite wall of the water tank causes a significant increase of the local throttling losses. But on the other hand, these local throttling losses cause a particularly uniform flow through the individual flat tubes of the heat exchanger matrix. The consequence is that even at a relatively low coolant flow rate through the flat tubes of the matrix the uniform distribution of flow and temperature are still very well.

In contrary to the approach according to the invention, conventional series heat exchangers are designed for high coolant flow rates and hence pressure losses which are as small as possible. For this reason the dimensions of hu are substantially larger in all known passenger vehicle heat exchangers, in order to minimize the pressure losses during the redirection of the coolant flow in the redirection water tank 300. Normally the dimensions hu and ho there are approximately the same. But surprisingly, the increase of the pressure loss conditional on the principle according to the further development into a four-stage heat exchanger inclusive the increase of the pressure loss due to the extremely small redirection water tank, is rather an advantage than a disadvantage. Here it is important that the installation space of the PTC is available for the heat exchanger and that the overall system is capable of replacing the PTC auxiliary heater with regard to its power.

Finally, this way leads to considerable savings of manufacturing costs and fuel.

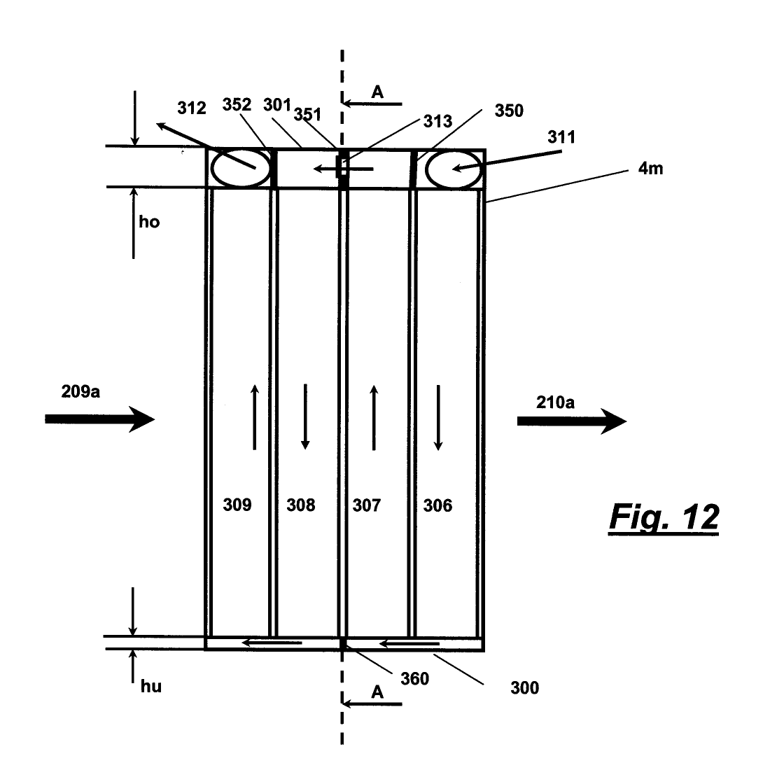

It is a particular advantage, especially in applications requiring particularly low coolant flow rates, if throttling of the coolant flow rate of the heat exchanger to the custom-designed target coolant flow rate takes place as illustrated in FIG. 12 by means of a panel or a flow crossover pipe 313 between stage 2 and stage 3. If necessary, this allows throttling in a further step, wherein it is particularly advantageous that in this cross section constriction the coolant is not only throttled to some extent, but necessarily also thoroughly mixed prior to or at the time of its transfer from the second to the third stage of the heat exchanger.

This measure for throttling and mixing between stage 2 and stage 3 especially has a positive effect on the startup of the heat exchanger when the coolant is very cold and when the admission of air is non-uniform, since in this way every single stage exhibits more homogeneous inlet temperatures of the coolant across the width of the water tank. Through this measure, inhomogeneities of the coolant temperatures become less strong from stage to stage in the cross-counterflow operation, because an evasion of the coolant flow to passages having a higher coolant temperature or a lower coolant viscosity is induced to a lesser extent. The homogenization of the flow is supported in case also by the increase of the pressure loss during inflow and outflow in the redirection water tank 300 having a smaller construction height hu. The customized adjustment of the pressure loss can be selectively effected in the end via the dimension hu or by the flow crossover cross section 313—which is much easier in many cases—or also by a combination of both measures.

The coolant-side throttling effect provided by these measures is a welcome side effect in many applications, because it increases the coolant temperature spread at the heat exchanger and in case also at the motor, thus improving the heating, provided that the heat exchanger is sufficiently dimensioned.

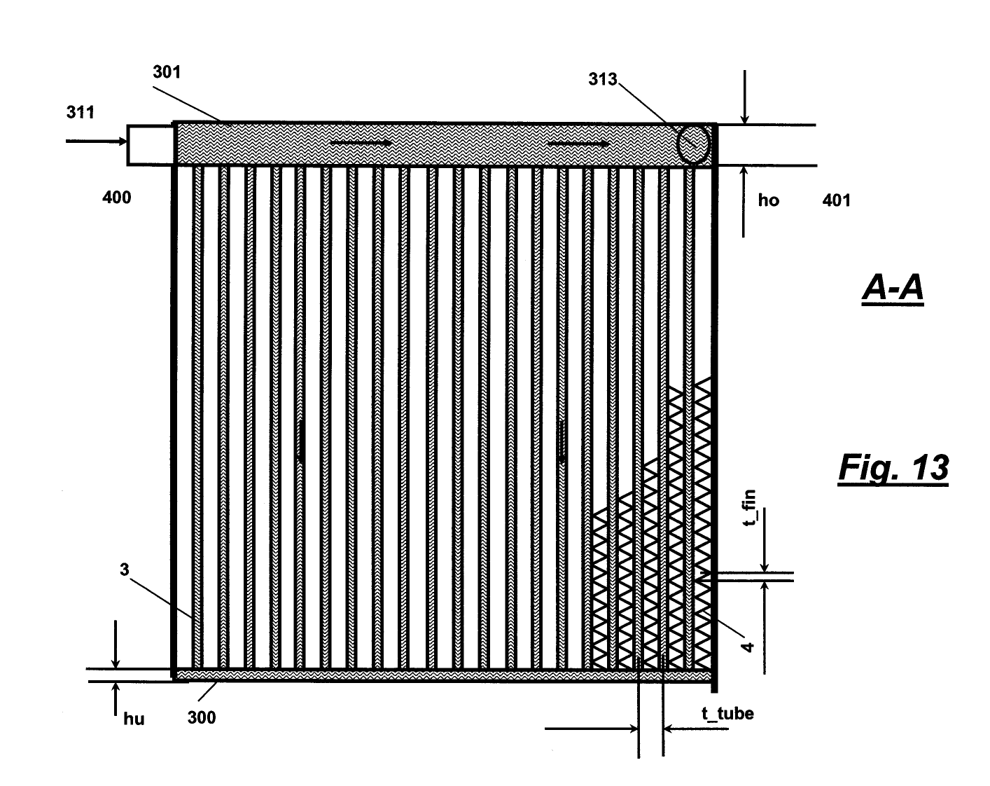

As shown in the FIGS. 12 and 13, in the case of very small target values of the heater coolant flow rate it is particularly advantageous if the crossover from stage 2 to stage 3 does not take place across the entire width of the water tank—as this is usual for minimizing pressure losses in modern vehicle heat exchangers, but if the entire coolant volume flow is allowed to pass through a common bore or a common connection passage to the water tank of the third stage, for mixing. Here the coolant supply takes place through the inlet or the supply connection 311, the first cross-over stage being formed by the series of flat tubes 306, with a first redirection to the second cross-flow stage 307 taking place in the water tank 300. The cross-over from the second to the third cross-flow stage 308 takes place through the connection opening 313 in which the coolant is necessarily thoroughly mixed and thermally harmonized prior to the third stage. The mixing position 313 is preferably incorporated in the water tank 301. Here it is important that a further harmonization of the coolant temperature takes place before the third stage. Depending on the installation position and on the demand for venting, a small additional vent bore in the water tank partition 360 or 350/352 (or generally in a corresponding partition) guarantees safe operation.

The simultaneous changeover to four cross-counterflow stages instead of two as provided in today's large-scale passenger vehicles and the installation of additional throttle positions for homogenizing the flow through the heat exchanger and the temperature distribution constitute additional preferred steps for improving the heat exchanger according to the invention. Corresponding tests in vehicles have shown that the accompanying increase of the pressure loss in the heating branch can be handled with known motor coolant pump characteristics. This is especially the case, because in many applications a reduction of the coolant through-flow in the heating branch by using such high-performance heat exchangers has an advantageous effect on the heating power.

In addition to the 4-stage configuration, the heat exchanger according to the invention is characterized in that it includes internal construction features which on the one side increase the coolant-side pressure loss due to the principle used and thus lower the coolant flow rate in the vehicle heating circuit and on the other side preferably provide for a reduced drop in efficiency at smaller to medium coolant flow rates by the additional mixing action between stage 2 and stage 3. Such a construction feature is represented by the flow crossover passage 313. This is constituted in the simplest way by a panel bore 313a in the partition plate 351. The central partition wall 351 of the connection water tank 301 preferably includes a panel-like flow crossover 313 between stage 2 and stage 3 in which the coolant cooled in the first two stages is throttled and simultaneously largely harmonized. The redirection water tank 300 on the coolant-side tube end of the heat exchanger matrix comprises precisely one partition wall 360 defining the four-stage configuration which means that the flow is merely redirected there. The transverse mixing is comparatively relatively unimportant, quite contrary to the mixing between stage 2 and stage 3 in the water tank. It will be understood that normally the partition essentially has the function of a separating element and thus is not required being a load-bearing construction, though this may be the case.

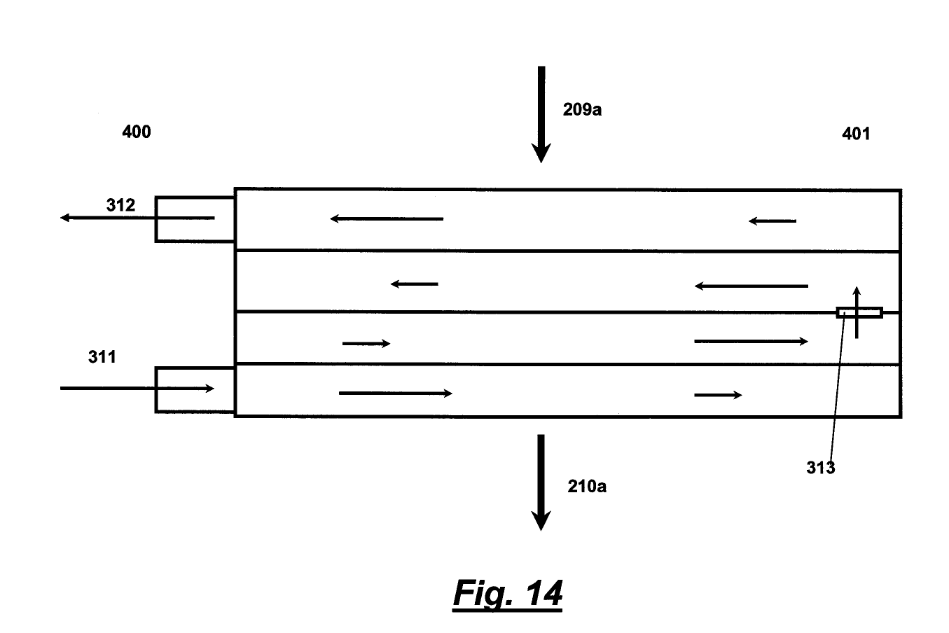

It is particularly advantageous if the inlet connection 311 and the outlet connection 312 are situated on the same side 400 of the connection water tank 301, as illustrated in the FIGS. 12 and 13, and if the flow crossover 313 of the partition 351 is situated on the opposite side 401 of the connection water tank 301, in particular close to that flat tube of the heat exchanger matrix which is furthest away from the inlet and outlet connections 311/312. This arrangement provides for a particularly good uniform distribution of flow to the individual flat tubes of the heat exchanger. This is due among others to the fact that the dynamic pressure in the water tank 301 is largely compensated in total over all four stages because of the transverse flow relative to the flat tubes of the heat exchanger. This is symbolized in FIG. 14 by the length of the flow arrows in the water tank 301: On average the number of short and long arrows, i.e. the number of matrix flat tube inlet and outlet positions with an increased or reduced dynamic and hence oppositely varying static pressure is the same over all four stages.

According to the FIGS. 11 and 12, a heat exchanger of the invention is particularly easy to manufacture if the redirection water tank 300 includes precisely one partition 360.

To achieve good mixing between stage 2 and stage 3 it is particularly advantageous for the flow crossover section 313 having a cross sectional area of flow which is equal to or smaller than the cross sectional area of flow of the inlet connection 311. This additionally guarantees that the heat exchanger also causes minimum throttling of the coolant flow rate as present in the cold and warm condition of the coolant, i.e. the heat exchanger flow rate varies less in dependence of the coolant temperature than this is the case in heat exchangers without the internal throttling by means of the flow crossover cross section 313 and, if necessary, with the small construction height hu of the redirection water tank.

If the known directives for the venting of heat exchangers are observed, the heat exchanger according to the invention can be installed in the most varying installation positions, for instance in upright or horizontal position, and if necessary with additional vent bore in the mm range, e.g. in the rage of 1-2 mm or 2-3 mm.

Particularly advantageous is an arrangement in which the heat exchanger is displaced parallel to the flat tubes of the heat exchanger during installation. In this case and possibly also independently of this case such a heat exchanger provides is particularly efficient concerning its construction space, if the connection water tank 301 in the installed condition closes the aperture for the installation and de-installation of the heat exchanger, especially if the same at least partly projects from the heating/air-conditioning device. The redirection water tank 300 and the two heat exchanger side surfaces can rest against the flow-determining inner walls of the heating/air-conditioning device and/or are sealed there against leak air past the heat exchanger. In addition to the advantages during installation and de-installation and during sealing, the obstruction of the air flow in this arrangement is particularly little, i.e. the air-side pressure loss is particularly low thanks to the small construction height hu of the redirection water tank 300 and to the arrangement of the connection water tank 301 largely outside the actual air flow path. Thus the effective size of the heat exchanger matrix is maximized in many applications typical for vehicles.

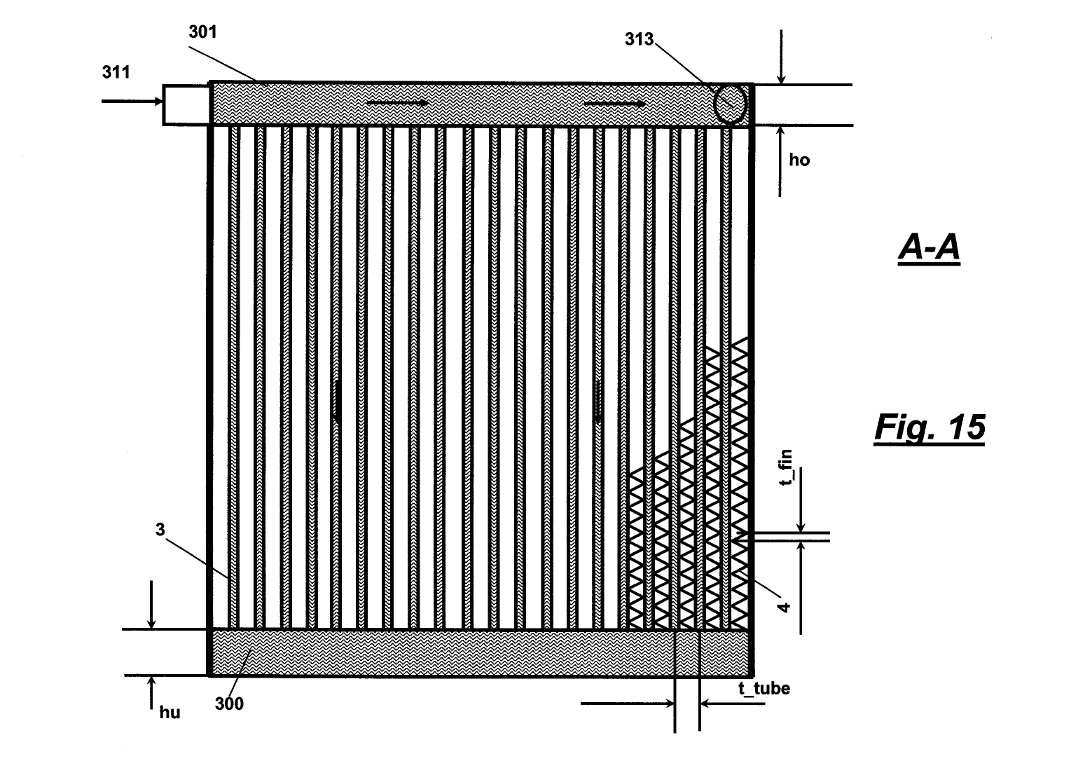

The small construction height hu is not necessarily required, but it is very helpful in implementing a heat exchanger that is particularly efficient with regard to low to medium coolant flow rates. In this context even the 4-stage heat exchanger according to FIG. 15 means a significant improvement compared to previously known heat exchangers in large-scale passenger vehicles.

FIG. 15 shows in a cross section a modification of a heat exchanger of the invention corresponding to FIG. 13, wherein the central partition 351 also includes a panel-like flow crossover 313 between stage 2 and stage 3, but wherein contrary to FIG. 13 the upper and the lower water tank 300, 301 have substantially the same construction height.

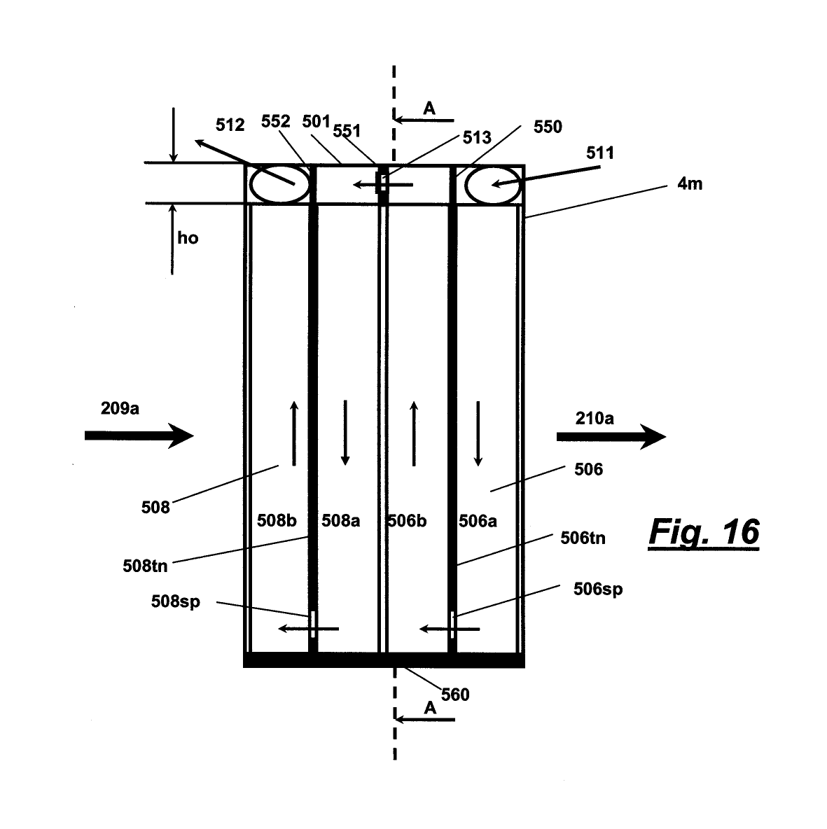

A modification of a heat exchanger according to the FIGS. 11 to 15 is shown by way of an example in the FIGS. 16 to 18, wherein in these Figs. identical reference numbers (if necessary increased by 200) have the identical denotation. Unless the following description mentions anything different, reference is made to the above description, particularly to the embodiment of the FIGS. 11 to 15. This further improvement is particularly advantageous in context with embodiments of the present invention, but also independently thereof.

The following embodiment solves the problem of providing a passenger vehicle series heat exchanger that exhibits an improved efficiency at a small to medium coolant flow rate, thus increasing the scope of dimensioning with regard to a maximally possible increase of the heating power and/or reducing the air-side pressure loss and/or the heat exchanger installation space while having the same heat exchanger efficiency and the same pressure loss as conventional heat exchangers, wherein the manufacturing advantages which are due to the principle used must be particularly emphasized. This concerns especially the omission of the lower water tank and the potential to successfully employ the technique according to invention also in plate-like heat exchangers. This enables the cost being further reduced especially in the case of high quantities. Moreover, a further increase of the effective matrix volume and/or lowering of the air-side pressure loss are made possible.

The inlet connection 511 and the outlet connection 512 can be situated on the same side 600 of the connection water tank 501, and the flow crossover 513 of the partition plane 551 can be situated on the opposite side 601 of the connection water tank 501, especially close to that flat tube of the heat exchanger matrix which is furthest away from the inlet and outlet connections 511/512.

Also this further development necessarily delivers again a coolant-side pressure loss which is somewhat higher than in a conventional four-stage heat exchanger providing a conventional water tank redirection across the entire width of the matrix, i.e. without a throttle and mixing position 513.

It is particularly advantageous that the throttling of the heat exchanger coolant flow rate to the target coolant flow rate specific to the application is implemented by a panel or a flow crossover tube 513 between stage 2 and stage 3. This results in the benefit that the coolant prior to or during the transfer from the second to the third stage of the heat exchanger is not only slightly throttled in this cross-sectional constriction, but is necessarily also thoroughly mixed. As in the previously described further development, this measure for throttling and mixing between the second and the third stage has a particularly positive effect on the startup of the heat exchanger when the coolant is very cold and when the air admission is non-uniform.

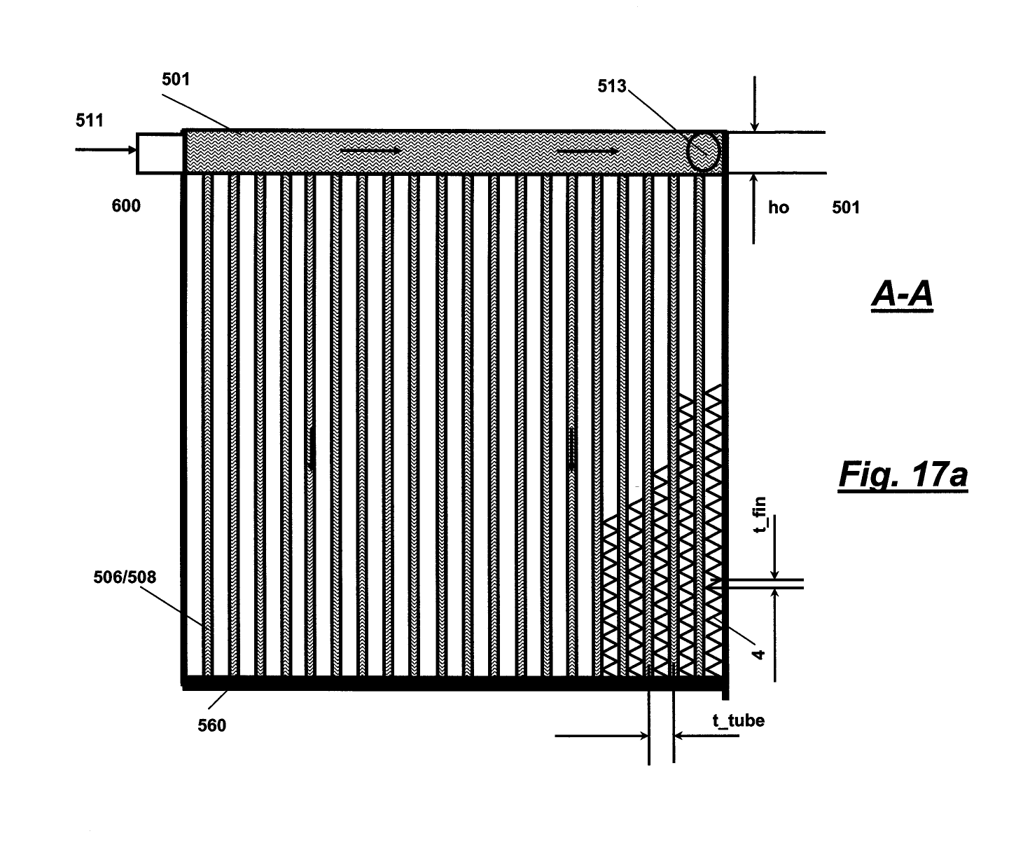

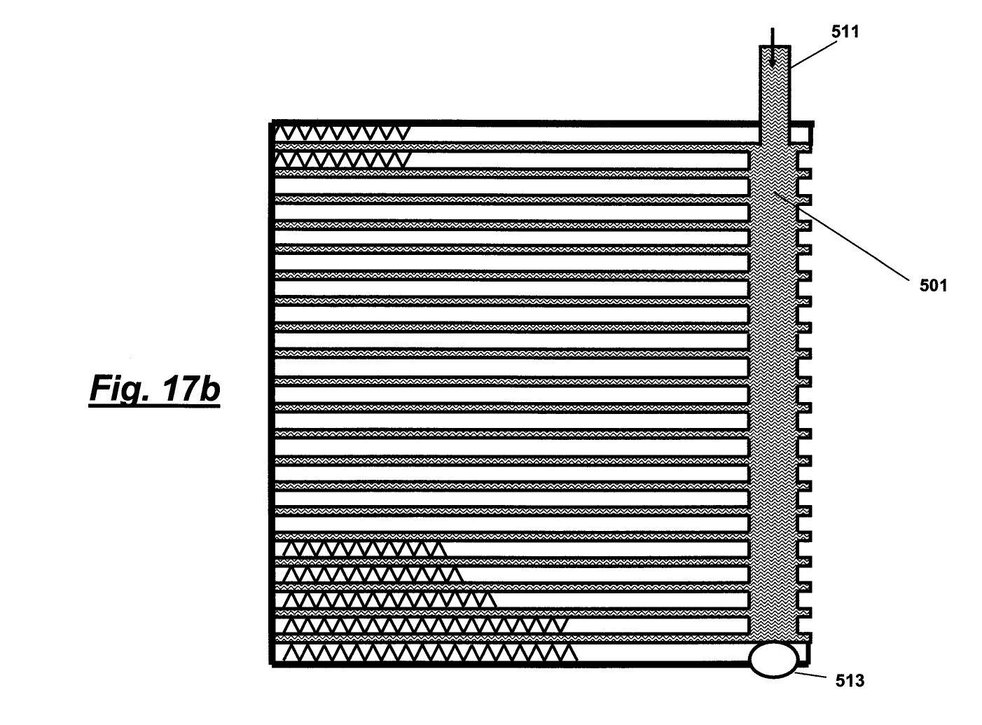

As illustrated in the FIGS. 16, 17 and differently from the way usual today for minimizing the pressure loss in passenger vehicle heat exchangers, the cross over from stage 2 to stage 3 does not take place across the entire width of the water tank, but at the time when the entire coolant volume flow for mixing thereof is passed to the water tank of the next stage through a common bore or common connection passage. According to FIG. 16, the coolant supply takes place through the inlet 511, the first cross-flow stage being formed by the series of flat tubes 506 together with the individual passages 506a and 506b. The redirection towards the second counterflow stage takes place inside the double tube 506 by means of the cross over gap 506sp. This is implemented in the simplest way by a flat double tube 506 being formed by welding the separation seam 605nt close to the tube end. A short interruption of the welding seam of e.g. 10-15 mm length then forms the redirection of the flow from stage 1 to stage 2 or from stage 3 to stage 4 at each individual flat double tube. On the front side the double tubes 506 and 508 are closed by the cover plate 560. The cross over from the second to the third cross-flow stage takes place through the connection opening 513 in which the coolant is necessarily mixed and thus thermally harmonized before the third stage. The mixing position 513 is preferably incorporated in the water tank 501. Here it is important that an extensive harmonization of the temperature of the coolant takes place before the third stage. Depending on the installation position and on the demand for venting, a small additional vent bore in the water tank partitions 550/552 guarantees safe operation.

As in the further development according to the FIGS. 11-15, a flow crossover passage 513 is provided which can be formed in the simplest way by a panel bore 513 in the partition plate 551, which is incidentally referred to. The central separation plane 551 of the connection water tank 501 can again include a panel-like flow crossover 513 between stage 2 and stage 3, in which the coolant that has been cooled in the first two stages is throttled and largely homogenized. The redirection between stage 1 and stage 2 as well as between stage 3 and stage 4 on the other coolant-side tube end of the heat exchanger matrix can take place without transverse mixing within the individual flat double tubes 506 and 508.

Due to the good uniform distribution of the flow and the temperature of the heat exchanger according to the invention and due to the matrix volume gained by the omission of the redirection water tank, the possibility exists for further improving the efficiency of the heat exchanger and/or for providing additional construction space for maximizing the volume of the heat exchanger matrix. Further, the heat exchanger is particularly easy to manufacture.

Particularly advantageous is the arrangement in which the heat exchanger is displaced parallel to the flat tubes of the heat exchanger during installation and de-installation. If the connection water tank 501 in the installed position closes the installation aperture for installation and de-installation of the heat exchanger, particularly if it projects at least partly from the heating/air-conditioning device, the front side and the two lateral surfaces of the of the heat exchanger rest against the flow-determining inner walls of the heating/air-conditioning device and/or are sealed there against leak air passing past the heat exchanger matrix. With this arrangement the obstruction of the air flow is particularly little, i.e. due to the omission of the redirection water tank 500 and due to the arrangement of the connection water tank 501 largely outside the actual air flow path, the pressure loss is particularly small, so that the effective size of the heat exchanger matrix can become maximum.

Instead of two flat double tubes also a plate construction of the flat tubes or of the entire heat exchanger can be selected at a correspondingly high quantity. In this case the flat tubes 506a, 506b, 508a and 508b for example having separation planes 506tn and 508tn are formed by joining prefabricated plates, and the two flow crossover positions 506sp and 508sp defining the four-stage configuration are formed by the separation planes 506tn and 508tn including an interruption close to the ends of the flat tubes, for redirecting the flow for the subsequent counterflow stage. Corresponding to FIG. 16, the connection water tank can be formed by the individual flat tube passages being installed and sealed in a corresponding hole pattern of a water tank bottom, and the separation planes 550, 551 and 552 being formed by means of separation plates or separation walls and a water tank cover including the coolant connections 511 and 512.

For this embodiment reference is made also to FIG. 14 which correspondingly applies.

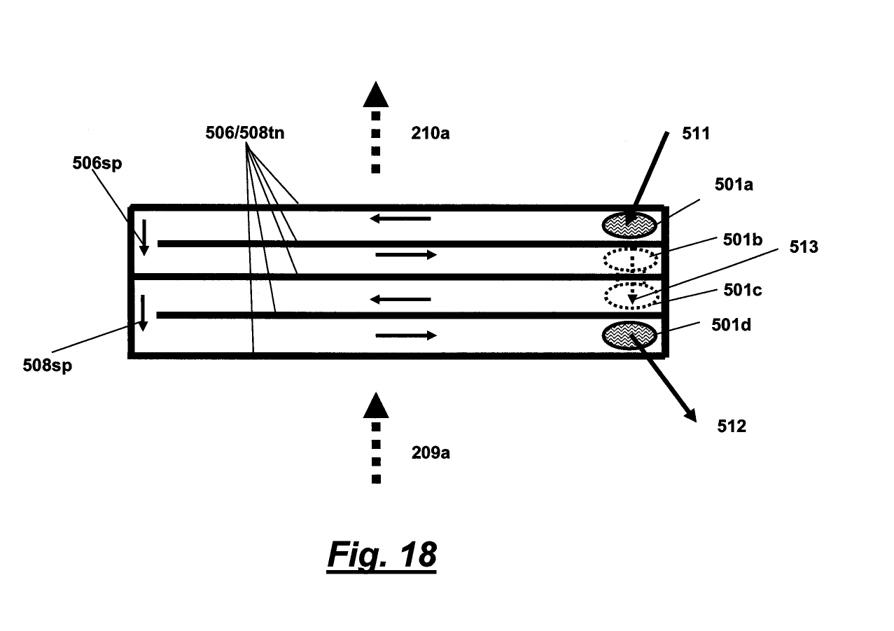

The FIGS. 17, 18 show a further particularly advantageous embodiment in the form of a plate heat exchanger. In this case the connection water tank 501 is constituted by the individual flat tube passages being formed in such a way that joining the individual water-side heat exchanger plates forms the flat tube passages 506a, 506b, 508a, 508b with their flow crossover positions 506sp and 508sp at the time with the four collecting tubes 501a, 501b, 501c and 501d. The collecting tube 510a serves as connection for the coolant supply, the collecting tube 501d as a connection for the coolant discharge, and the flow crossover connection 513 takes over the throttling and extensive mixing of the coolant of the second counterflow stage, which has accumulated in the collecting tube 501b, before entering the collecting tube 501c of the third counterflow stage. In this case, too the coolant is intentionally collected and mixed between stage 2 and stage 3, before it flows into the third stage, thus guaranteeing a certain throttling and simultaneously a good uniform distribution of the temperature.

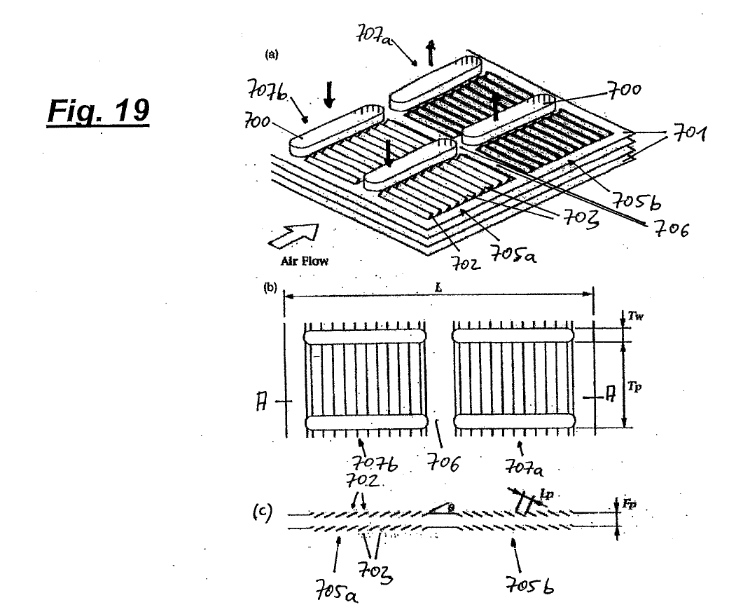

FIG. 19 schematically shows a part of a heat exchanger in a perspective view (FIG. 19a), in a plan view (FIG. 19b) and in cross section (FIG. 19c) along line A-A. The coolant-side flat tubes 700, of which only sections are shown, include air-side heat exchanger fins 701 that can connect the flat tubes with each other through which coolant can flow in the direction of the arrow (black arrows). The flat tubes can run through the plates forming the fins. It will be understood that the fins can be formed and connected to the flat tubes also in a different manner. For instance, the fins can be formed according to a zigzag pattern, as indicated in the FIGS. 13, 15 etc. The fins 701 have recesses 702 producing turbulences, said recesses being formed by notches 703 in the fins or sheet metal layers or in case also by recesses in the fins. The recesses of adjacent areas 705a, 705b can be pitched in a different direction with respect to the flow direction, as indicated in FIG. 19c. The fin spacing here is the distance of the sheet metal layers transversely or vertically to the air flow direction (open arrow). The empty intermediate spaces 706 between the individual groups of heat exchanger tubes 707a, b are part of the matrix volume, which generally applies within the scope of the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1-32. (canceled)

33. A high-performance heat exchanger for providing air-conditioning of a vehicle cab of a passenger car below 2000 kg empty weight and installed within a vehicle platform in more than 50,000 vehicles per year, said air conditioning being performed using exhaust heat of a liquid-cooled driving engine and/or its components or other heat sources of a cooling and/or heating circuit, wherein the heat exchanger includes a soldered heat transfer matrix comprising coolant-side flat tubes and air-side fins having a plurality of turbulence-producing recesses following each other in an air flow direction and capable of being washed round from heating air, wherein a heat transfer matrix has a volume V_matrix, a center-to-center spacing of air-side fins t_fin and a center-to-center spacing of coolant flat tubes t_tube, such that a specific heat exchanger volume V_spec produced therefrom using the equation V_spec=V_matrix/(t_tube+(4*t_fin)) exceeds a lower limit value of 0.140 m².

34. The heat exchanger according to claim 33, wherein the volume of the heat exchanger matrix V_matrix is at least 1.41.

35. The heat exchanger according to claim 33, wherein the center-to-center tube spacing t_tube of parallel flown-through coolant-side flow passages is less than 7 mm and/or the center-to-center spacing of the parallel flown-through heat transfer fins is less than 1 mm and/or that the coolant-side flow passages are formed as flat tube-like passages having a passage height of less than 1 mm.

36. The heat exchanger according to claim 33, wherein the heat exchanger has at least one stage comprising:
a soldered heat exchanger fin-tube matrix in a cross-flow design having a matrix volume V_matrix of the heat exchanger of totally more than 1.4 l in a matrix design,
flat tube-like heat exchanger passages for liquid coolant having a center-to-center flat tube spacing t_tube of less than 7 mm, and
air-side flow passages formed by surfaces of coolant-side heat exchanger passages facing away from the coolant and air-side metal fins soldered to them and having a plurality of turbulence-producing recesses of air-side heat transfer fins transversely to the air flow and a center-to-center fin spacing t_fin of less 1.3 mm.

37. The heat exchanger according to claim 33, wherein the volume of the heat exchanger matrix V_matrix is larger than 1.7 l, the center-to-center spacing of the air-side heat transfer fins t_fin is smaller than 0.8 mm, the center-to-center spacing of the parallel flown-through coolant-side flow passages t_tube is 9-11 mm, and the coolant-side flow passages are formed as flat tube-like passages having a passage height of 1-1.5 mm.

38. The heat exchanger according to claim 33, wherein the flat tube center-to-center spacing t_tube is less than 7 mm, and is adapted in such a manner that at an inlet temperature difference of 100° K. and at a mass air flow of 6 kg/min it exhibits a specific power of less than 7.1 kW per liter of heat exchanger matrix volume.

39. The heat exchanger according to claim 33, wherein the heat exchanger has a construction depth in an air flow direction of more than 48 mm.

40. The heat exchanger according to claim 33, wherein the heat exchanger has an isothermal pressure loss of more than 200 Pa at 6 kg/min air of 25° C. and/or an isothermal coolant-side pressure loss of more than 40 mbar at a coolant flow rate of 5 l/min and at coolant temperature of 80° C.

41. The heat exchanger according to claim 33, wherein the heat exchanger is adapted for or associated with a vehicle having a vehicle empty weight of ≦1400 kg and has a flat tube-fin matrix volume V_matrix of more than 1.08 l, a center-to-center tube spacing t_tube of less than 6.5 mm as well as a center-to-center fin spacing t_fin of less than 1.3 mm.

42. The heat exchanger according to claim 33, wherein the heat exchanger is adapted for or associated with a vehicle having a vehicle empty weight of ≧1400 kg and ≦2000 kg and has a flat tube-fin matrix volume V_matrix of more than 1.48 l, a center-to-center tube spacing t_tube of less than 6.5 mm as well as a center-to-center fin spacing t_fin of less than 1.3 mm.

43. The heat exchanger according to claim 33, wherein the heat exchanger is constructed from at least two cross-flow heat exchangers in a cross-counterflow design and means are provided for mixing and throttling the coolant by cross-sectional constrictions before or during cross over from one stage of the heat exchanger to the next.

44. The heat exchanger according to claim 43, wherein as a mixing means between a first water tank and a water tank following the first water tank a partition having a bore interconnecting the tanks or a common connection passage are provided, such that mixing takes place by passing at least more than 90% of coolant volume flow of the first water tank through the bore or the connection passage to the following water tank of the next stage.

45. The heat exchanger according to claim 43, wherein the mixing means are provided only between a penultimate and an ultimate stage, such that mixing takes place only during flow crossover to the ultimate, coldest stage on the coolant side.

46. The heat exchanger according to claim 33, wherein the heat exchanger is constructed from precisely four cross-flow heat exchangers connected in series in a cross-counterflow and
includes on a coolant-side tube end of the heat exchanger matrix a connection water tank (301) having an inlet connection (311) and an outlet connection (312) for the coolant, which is divided by two partition walls (350, 352) for producing the cross-counterflow, and
includes on the other coolant-side tube end of the heat exchanger matrix a redirection water tank (300) having precisely one partition wall (360) defining the four-stage configuration and wherein
(1) the redirection water tank (300) has a coolant-side construction height hu which is less than 30% of the coolant-side construction height of the connection water tank (201) and/or
(2) an additional central partition (351) of the connection water tank (301) comprises a panel-like flow crossover (313) between stage 2 and stage 3, in which the coolant that has been cooled in the first two stages is throttled and simultaneously largely homogenized.

47. The heat exchanger according to claim 46, wherein the inlet connection (311) and outlet connection (312) are situated on a same side (400) of the connection water tank (301), and wherein the flow crossover (313) of the partition (351) is situated on an opposite side (401) of the connection water tank.

48. The heat exchanger according to claim 33, wherein the heat exchanger comprises a soldered heat transfer matrix comprising four coolant-side flat tubes, each having a flat tube passage (506a,b; 508a,b) and air-side fins having a plurality of turbulence-producing recesses following each other in an air flow direction, and wherein the heat exchanger:
is constructed from precisely four cross-flow heat exchangers connected in series in a cross-counterflow,
includes on a first coolant-side tube end of the heat exchanger matrix a connection water tank (501) having an inlet connection (511) and an outlet connection (512) for the coolant, which is divided by three partitions (550, 551 and 552) for producing the cross-counterflow,
includes on another coolant-side tube end of the heat exchanger matrix a coolant crossover gap (506sp) incorporated into the coolant-side flat tube passages and defines the four-stage configuration, wherein a first crossover gap is provided between flat tubes of a first pair of adjacent flat tube passages (506a, 506b) and a further coolant crossover gap (508sp) is provided between a second pair of flat tube passages (508a, 508b), and
a central partition plane (251) of the connection water tank (501) includes a panel-like flow crossover (513) between stage 2 and stage 3, such that coolant that has been cooled in the first two stages is throttled and at least substantially homogenized.

49. The heat exchanger according to claim 48, wherein the heat exchanger is constructed from flat double tubes (506) and (508) having separation seams (506tn), and the two flow crossovers (506sp) and (508sp) of the individual flat tubes defining the four-stage configuration are formed by separation seams (506tn) and (508tn) including an interruption close to the flat tube ends, for redirecting flow for the following counterflow stage and/or wherein the flat tubes (506a, 506b, 508a, 508b) have separation planes (506tn) and (508tn) are formed by joining pre-formed plates, and the two flow crossovers (506sp) (508sp) defining the four-stage configuration are formed by the separation planes (506tn) and (508tn) including an interruption close to the flat tube end, for redirecting flow for the following counterflow stage.

50. The heat exchanger according to claim 49, wherein the connection water tank (501) is made up using individual flat tubes having flat tube passages in such a manner that the individual flat tube passages simultaneously form the flat tube passages (506a, 506b, 508a, 508b) together with the crossover positions (506sp) and (508sp) and for collecting tubes (501a, 501b, 501c and 501d) that are each assigned to one counterflow stage, by joining individual water-side heat exchanger plates.

51. The heat exchanger according to claim 50, wherein four collecting tubes are provided, a first collecting tube (501a) forming a connection for coolant supply, a fourth collecting tube (501d) forming a connection for coolant discharge, and the flow crossover connection (513) being adapted for throttling and further mixing coolant of a second counterflow stage collected in the collecting tube (501b) before entry into a third collecting tube (501c) of a third counterflow stage.

52. A heating/air-conditioning device for providing air-conditioning of a vehicle cab of a passenger car having an empty weight below 2000 kg, the device being used within a vehicle platform with more than 50,000 vehicles per year and comprising a high-performance heat exchanger according to claim 33.

53. The heating/air-conditioning device according to claim 52, wherein front foot vents of a vehicle cab of a passenger car are assigned to the heating/air-conditioning device, which front foot vents conduct or are designed for conducting heated air to a foot space of the vehicle cab of a passenger car by the heating/air-conditioning device, and wherein the heating device comprises temperature control flaps, wherein the heating/air-conditioning device comprises a heat exchanger exhibiting a specific heat exchanger volume V_spec and the temperature control flaps of the heating device being designed with a tightness such that the heat exchanger achieves at an operating point, at which the air inlet temperature (T_{air, heat exchanger,inlet}) is −20°, a coolant inlet temperature (T_{coolant, heat exchanger,inlet}) is 50° C., a heating air mass flow is 5 kg/min and a coolant flow rate is 5 l/min and with an air mass flow delivered by it and its heating power being focused on the foot vents, an average air outlet temperature at front foot vents (T_{air, foot vent, front}) which is as high a total heat efficiency Phi obtained by the equation Phi=100*(T_{air, foot vent, front})−T_{air, heat exchanger,inlet})/(T_{coolant, heat exchanger,inlet}−T_{air, heat exchanger,inlet}) exceeds a value of 85%, without air-side auxiliary heaters.

54. The heating/air-conditioning device according to claim 53, wherein the heating/air-conditioning device is so designed that the total heat efficiency Phi obtained by the equation Phi=100*(T_{air, foot vent, front})−T_{air, heat exchanger,inlet})/(T_{coolant, heat exchanger,inlet}−T_{air, heat exchanger,inlet}) remains above 80% at operating temperatures of −20° C. air inlet temperature and +50° C. coolant inlet temperature at a travelling speed profile according to MVEGA (Motor Vehicle Emission Group of Automobiles) in all travelling speeds including an idling speed, without air-side auxiliary heaters.

55. The heating/air-conditioning device according to claims 52, wherein the device does not include any preparatory measures in a form of one or more features selected from a construction volume kept in readiness, fixing devices, electric connections for an air-side PTC auxiliary heating, and air-side auxiliary heating devices.

56. The heating/air-conditioning device according to claim 52, wherein the device is designed in such a manner that it enables a main coolant flow for cooling a combustion engine in a first operation mode, in which exhaust heat delivered to the coolant is less than 5 kW, primarily flowing through the heat exchanger, and in a second mode of operation, in which the exhaust heat is comparatively high (in this case the exhaust would have to be more precisely defined, e.g. (1) “higher” than in the first operation mode or (2) higher than x kW or (3) by more than y kW higher than the exhaust heat delivered in the first mode of operation) and/or with coolant temperatures of 10K above an earliest opening temperature of a vehicle radiator branch settable in the vehicle or thermostatically preset, said main coolant flow also flowing through a vehicle radiator and/or a radiator bypass, and that in the second operation mode in a speed range of the combustion engine close to an idling speed less than 2.5 l of coolant flow through the heat exchanger even at a high to maximum demand of cab heating.

57. The heating/air-conditioning device according to claim 52, wherein an air-side temperature control device having control flaps and servomotors for controlling the control flaps are provided, which are designed in such a manner that when heating is fully open more than 95% of air supplied to the vehicle cab passing through the heat exchanger matrix.

58. The heating/air-conditioning device according to claim 52, wherein the heating/air-conditioning device is assigned to or incorporated in a passenger car, wherein the device does not include an air-side auxiliary heater, and wherein the device is so designed that in a winter test constant ride at
50 km/h in a gear stage automatically set by an automatic transmission or, in a manual transmission, in a highest gear allowing smooth travelling,
−20° C. ambient temperature and
a setting of the heater to maximum heating
a coolant temperature of 50° C. at a heat exchanger inlet and/or a coolant temperature of 40° C. at a heat exchanger outlet are not exceed in a period of first 30 minutes of the constant ride.

59. The heating/air-conditioning device according to claim 58, wherein the device is designed in such a manner that after a period of 15 minutes idling with the motor running and the vehicle stationary, which immediately follows the period of 30 minutes constant ride, the coolant temperature at the heat exchanger outlet drops to temperatures below 25° C.

60. The heating/air-conditioning device according to claim 52, wherein the heating/air-conditioning device is dedicated to or installed in a Diesel engine passenger car, wherein the heating/air-conditioning device does not include an auxiliary heater, and wherein the heat exchanger is made up from at least two series-connected cross-flow heat exchangers having specific individual powers of 8.0 kW per liter of heat exchanger matrix volume at a respective inlet temperature difference of 100 K and an air flow mass of 6 kg/min and a coolant flow rate of 10 l/min, said individual powers being reduced by a series connection to a specific power of less than 7.1 kW per liter of heat exchanger matrix volume at an inlet temperature difference of 100 K at the overall heat exchanger, 6 kg/min air, and 10 l/min coolant.

61. The heating/air-conditioning device according to claim 52, wherein the the device comprises at least two cross-flow heat exchangers connected in series in a cross-counterflow, and wherein a valve is provided which opens automatically above a certain coolant pressure difference and which temporarily or completely bypasses one or more cross-flow heat exchanger stages at extremely low coolant temperatures lower than −10° C., so that only individual regions of the heat exchanger are fully flown-through.

62. The heating/air-conditioning device according to claim 52, wherein the device comprises at least two individual heat exchangers connected in series in a cross-counterflow, the at least two heat exchangers having substantially the same structure and corresponding to each other at least substantially in all dimensions of the heat exchanger matrix and/or in dimensions of a water tank.

63. The heating/air-conditioning device according to claim 52, wherein the device is dedicated to or installed in a vehicle series comprising more than 50,000 vehicles per year, and wherein in this vehicle series all motors include a bypass branch (6b) and motor cooling circuit with a thermostat designed in such a manner that the bypass branch (6b) at motor powers of ≧50% of rated power and with the thermostat closed at least temporarily exhibits a coolant flow rate higher than a heating coolant flow rate.

64. A vehicle platform comprising more than 50,000 vehicles per year, each vehicle having an empty weight below 2000 kg, wherein each vehicles include at least one heat exchanger according to claim 33, each of said at least one heat exchanger being structurally identical within the vehicle platform.
